(19) United States
(12) Patent Application Publication
(10) Pub. No.: US 2022/0399827 A1
(43) Pub. Date: Dec. 15, 2022

(54) SWITCH DRIVING APPARATUS AND SWITCHING POWER SUPPLY INCLUDING SWITCH DRIVING APPARATUS

(71) Applicant: ROHM Co., LTD., Kyoto (JP)

(72) Inventor: Kenji HAMACHI, Kyoto (JP)

(21) Appl. No.: 17/658,327

(22) Filed: Apr. 7, 2022

(30) Foreign Application Priority Data
Jun. 9, 2021 (JP) 2021-096454

(51) Int. Cl. H02M 7/219; H02M 1/34; H02M 1/00

(52) U.S. Cl. CPC H02M 7/219; H02M 1/34; H02M 1/0054

(57) ABSTRACT

Provided is a switch driving apparatus including a controller configured to individually control a first switch element and a second switch element included in a bidirectional switch, in which, when the controller stops on/off drive of the bidirectional switch, the controller turns off both the first switch element and the second switch element and then temporarily turns on one of the first switch element and the second switch element for a predetermined on time period.

### CROSS REFERENCE TO RELATED APPLICATIONS

This application claims priority benefit of Japanese Patent Application No. JP 2021-096454 filed in the Japan Patent Office on Jun. 9, 2021. Each of the above-referenced applications is hereby incorporated herein by reference in its entirety.

### BACKGROUND

The technology disclosed in the present specification relates to a switch driving apparatus and a switching power supply including the switch driving apparatus.

In the past, the applicant of the present application has proposed a switch driving apparatus that can perform individual zero-voltage switching control (what is generally called zero-volt switching (ZVS) control) of a first switch element and a second switch element included in a bidirectional switch of a switching power supply and suppress heat generation of the bidirectional switch (see Japanese Patent Laid-Open No. 2021-13295).

### SUMMARY

However, the switch driving apparatus in the past still has room for improvement in suppressing resonance noise generated when on/off drive of the bidirectional switch is stopped.

It is desirable to provide a switch driving apparatus and a switching power supply including the switch driving apparatus that can suppress resonance noise.

For example, a switch driving apparatus disclosed in the present specification includes a controller configured to individually control a first switch element and a second switch element included in a bidirectional switch. In the switch driving apparatus, when the controller stops on/off drive of the bidirectional switch, the controller turns off both the first switch element and the second switch element and then temporarily turns on one of the first switch element and the second switch element for a predetermined on time period.

Other features, elements, steps, advantages, and characteristics will become more apparent from the following detailed description of the preferred embodiments and the attached drawings related to the embodiments.

The technology disclosed in the present specification can provide the switch driving apparatus and the switching power supply including the switch driving apparatus that can suppress resonance noise.

### BRIEF DESCRIPTION OF THE DRAWINGS

FIG. 1 illustrates a switching power supply according to a first embodiment;

FIG. 2 illustrates an equivalent circuit of a transformer;

FIG. 3 illustrates an equivalent circuit of a rectifier diode;

FIG. 4 illustrates a first example of individual ZVS control;

FIG. 5 illustrates a second example of the individual ZVS control;

FIG. 6 illustrates a third example of the individual ZVS control;

FIG. 7 illustrates a fourth example of the individual ZVS control;

FIG. 8 illustrates the switching power supply according to a second embodiment;

FIG. 9 illustrates the switching power supply according to a third embodiment;

FIG. 10 illustrates the switching power supply according to a fourth embodiment;

FIG. 11 illustrates a fifth example of the individual ZVS control;

FIG. 12 illustrates the switching power supply according to a fifth embodiment;

FIG. 13 illustrates the switching power supply according to a sixth embodiment;

FIG. 14 illustrates the switching power supply according to a seventh embodiment;

FIG. 15 illustrates the switching power supply according to an eighth embodiment;

FIG. 16 illustrates the switching power supply according to a ninth embodiment;

FIG. 17 illustrates a reduction in efficiency caused by a clamp operation;

FIG. 18 illustrates a configuration example of main parts of a controller;

FIG. 19 illustrates an internal control example of the controller;

FIG. 20 illustrates the switching power supply according to a tenth embodiment;

FIG. 21 illustrates a first operation example (V1>V2) of the individual ZVS control in the tenth embodiment;

FIG. 22 illustrates a current path in a first phase of the first operation example;

FIG. 23 illustrates a current path in a second phase of the first operation example;

FIG. 24 illustrates a current path in a third phase of the first operation example;

FIG. 25 illustrates a current path in a fourth phase of the first operation example;

FIG. 26 illustrates a current path in a fifth phase of the first operation example;

FIG. 27 illustrates a current path in a sixth phase of the first operation example;

FIG. 28 illustrates a current path in a seventh phase of the first operation example;

FIG. 29 illustrates a second operation example (V1<V2) of the individual ZVS control in the tenth embodiment;

FIG. 30 illustrates a current path in a first phase of the second operation example;

FIG. 31 illustrates a current path in a second phase of the second operation example;

FIG. 32 illustrates a current path in a third phase of the second operation example;

FIG. 33 illustrates a current path in a fourth phase of the second operation example;

FIG. 34 illustrates a current path in a fifth phase of the second operation example;

FIG. 35 illustrates a current path in a sixth phase of the second operation example;

FIG. 36 illustrates a current path in a seventh phase of the second operation example;

FIG. 37 illustrates a state in which on/off drive of a bidirectional switch is stopped at polarity inversion timing of an alternating current (AC) input voltage;

FIG. 38 is an enlarged view of a region a in FIG. 37;

FIG. 39 illustrates a first example of a drive stopping process; and

FIG. 40 illustrates a second example of the drive stopping process.

### DETAILED DESCRIPTION OF THE PREFERRED EMBODIMENTS

### First Embodiment

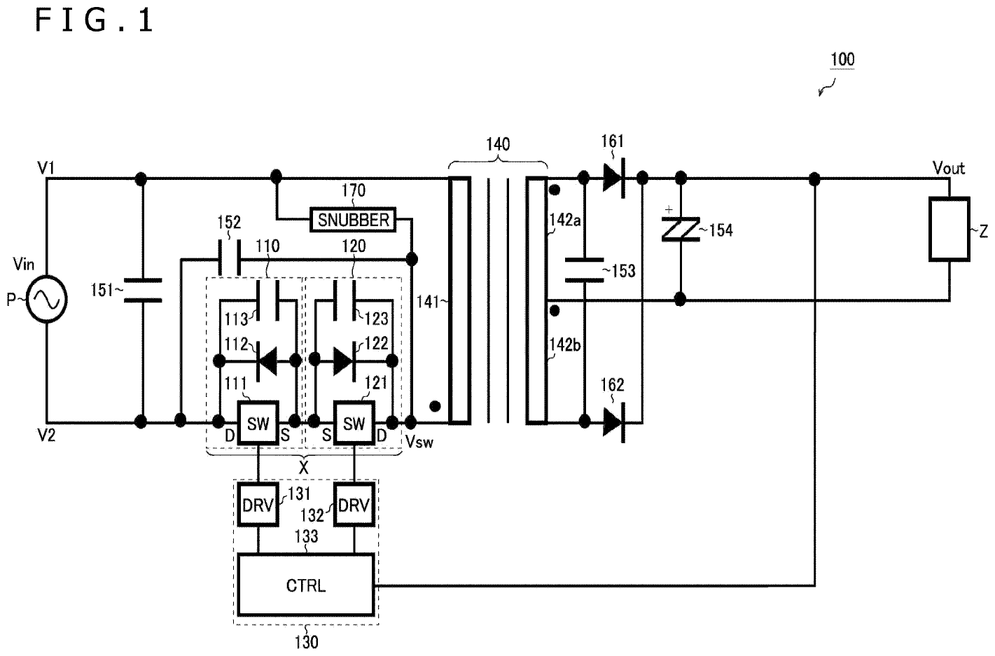

FIG. 1 illustrates a switching power supply according to a first embodiment. A switching power supply 100 of the present embodiment is an isolated alternating current/direct current (AC/DC) converter that directly converts an AC input voltage Vin (=V2−V1, for example, V1=GND) supplied from an AC power supply P into a DC output voltage Vout and that supplies the DC output voltage Vout to a load Z, while electrically isolating a primary circuit system and a secondary circuit system. The switching power supply 100 includes switch elements 110 and 120, a switch driving apparatus 130, a transformer 140, capacitors 151 to 154, diodes 161 and 162, and a snubber circuit 170.

The switch elements 110 and 120 are reversely connected in series between a second node of the AC power supply P (=application end of voltage V2) and a second input tap of the transformer 140 (=winding start end of primary winding 141). The switch elements 110 and 120 connected in this way form a bidirectional switch X connected in series to the primary winding 141 of the transformer 140.

When, for example, the switch elements 110 and 120 are Si-based or SiC-based N-channel type metal oxide semiconductor field effect transistors (NMOSFETs), sources S of the switch elements 110 and 120 are used in common. A drain D of the switch element 110 is connected to the second node of the AC power supply P, and a drain D of the switch element 120 (=application end of switch voltage Vsw) is connected to the second input tap of the transformer 140. Note that GaN devices or insulated gate bipolar transistors (IGBTs), for example, may be used for the switch elements 110 and 120.

The switch elements 110 and 120 include switch function units 111 and 121 (transistor bodies) as well as internal diodes 112 and 122 and internal capacitances 113 and 123, respectively. In the case of FIG. 1, a cathode of the internal diode 112 and a first end of the internal capacitance 113 are connected to a drain D of the switch function unit 111. An anode of the internal diode 112 and a second end of the internal capacitance 113 are connected to a source S of the switch function unit 111. Meanwhile, a cathode of the internal diode 122 and a first end of the internal capacitance 123 are connected to a drain D of the switch function unit 121. An anode of the internal diode 122 and a second end of the internal capacitance 123 are connected to a source S of the switch function unit 121.

The switch driving apparatus 130 includes drivers 131 and 132 that generate drive signals (gate signals) of the switch elements 110 and 120, respectively, and includes a controller 133 that controls the drivers 131 and 132. The switch driving apparatus 130 individually turns on/off the switch elements 110 and 120.

The switch driving apparatus 130 has, for example, a function (=output feedback control function) of turning on/off the bidirectional switch X to make the DC output voltage Vout in line with a desirable target value. The function allows stable supply of constant DC output voltage Vout to the load Z.

The switch driving apparatus 130 also has a function (=power factor improvement function) of turning on/off the bidirectional switch X to bring the power factor of the switching power supply 100 close to 1. A separate power factor improvement circuit may be unnecessary because of the function, and the function can realize a one-converter switching power supply 100.

The switch driving apparatus 130 also has a function (=individual ZVS function) of individually performing zero-voltage switching control for the switch elements 110 and 120. The function can reduce the switching loss of the bidirectional switch X. Hence, heat generation of the bidirectional switch X can be suppressed, and the conversion efficiency of the switching power supply 100 can be increased. The individual ZVS function will be described in detail later.

The transformer 140 includes the primary winding 141 provided in the primary circuit system, and secondary windings 142a and 142b provided in the secondary circuit system and magnetically coupled to the primary winding 141. A first input tap of the transformer 140 (=winding finish end of primary winding 141) is connected to a first node of the power supply P (=application end of voltage V1). The second input tap of the transformer 140 (=winding start end of primary winding 141) is connected to the second node of the AC power supply P (=application end of voltage V2) through the bidirectional switch X. A first output tap of the transformer 140 (=winding start end of secondary winding 142a) is connected to an anode of the diode 161. A second output tap of the transformer 140 (=winding finish end of secondary winding 142b) is connected to an anode of the diode 162. A third output tap of the transformer 140 (=winding finish end of secondary winding 142a and winding start end of secondary winding 142b) is connected as a ground of the secondary circuit system to a low potential end of the load Z.

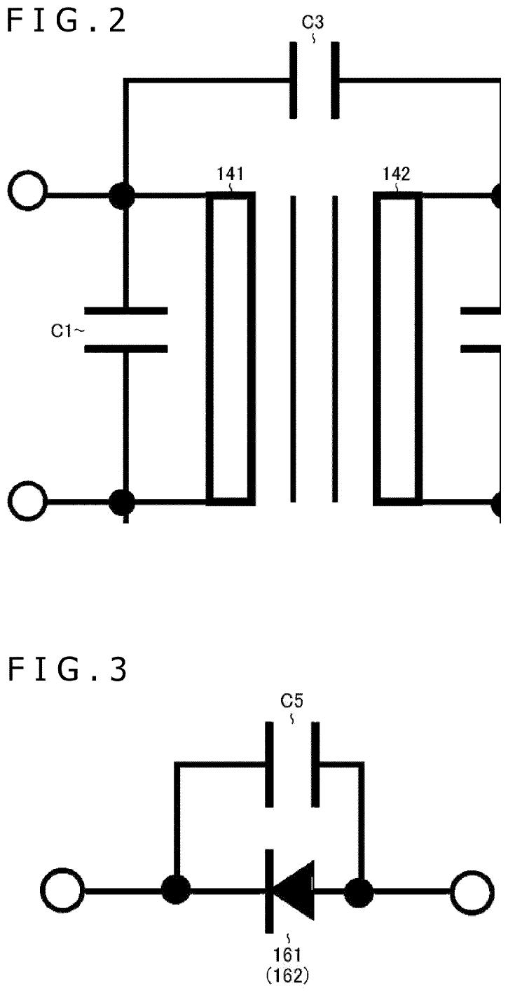

Note that a transformer with a high degree of coupling may be used as the transformer 140 to provide a flyback converter circuit, or a leakage transformer (resonant transformer) with a leakage inductance may be used as the transformer 140 to provide a voltage resonance circuit. A voltage resonance circuit including a coil connected to a leakage transformer may also be provided. The transformer 140 is provided with stray capacitances C1 to C4 as illustrated in FIG. 2.

The capacitor 151 is connected in parallel to the AC power supply P, and the capacitor 151 functions as an input filter capacitor that removes noise components of the AC input voltage Vin.

The capacitor 152 is connected in parallel to the bidirectional switch X, and along with the primary winding 141 and the leakage inductance (not illustrated) of the transformer 140, the capacitor 152 functions as a resonant capacitor included in the resonant circuit. The leakage transformer or the resonant transformer is used as the transformer 140. Accordingly, even if there is surplus energy not supplied from the primary winding 141 to the secondary windings 142a and 142b, the surplus energy can be regenerated and used, and the conversion efficiency of the switching power supply 100 is not reduced. Note that the switch elements 110 and 120 include the internal capacitances 113 and 123, respectively, and the capacitor 152 may be unnecessary in some cases.

The capacitor 153 is connected to the first output tap (winding start end of secondary winding 142a) and the second output tap (winding finish end of secondary winding 142b) of the transformer 140, and the capacitor 153 functions as a rectifier capacitor.

The capacitor 154 is connected in parallel to the load Z, and the capacitor 154 functions as a smoothing capacitor that smooths output of full-wave rectifier circuits (=diodes 161 and 162) to generate the DC output voltage Vout.

The anode of the diode 161 is connected to the first output tap of the transformer 140. The anode of the diode 162 is connected to the second output tap of the transformer 140. Cathodes of the diodes 161 and 162 are connected, as output ends of the DC output voltage Vout, to a high potential end of the load Z. The diodes 161 and 162 connected in this way function as full-wave rectifier circuits that perform full-wave rectification of induced voltages (=flyback voltages or forward voltages) generated in the secondary windings 142a and 142b. Note that each of the diodes 161 and 162 is provided with an internal capacitance C5 as illustrated in FIG. 3.

The snubber circuit 170 is connected to the ends of the primary winding 141, and the snubber circuit 170 plays a role of absorbing an excessive surge. However, the snubber circuit 170 may not be included if the energy fluctuation of the transformer 140 at the time that the bidirectional switch X is turned off is sufficiently small due to the action of the capacitor 152.

Note that the operation mode of the switching power supply 100 with the configuration is one of a first operation mode for using only a flyback system and a second operation mode for using both the flyback system and a forward system, depending on periodic AC fluctuation of the AC input voltage Vin.

In this way, both the forward voltages and the flyback voltages appearing at the secondary windings 142a and 142b can be taken out as output in the switching power supply 100 that uses both the flyback system and the forward system. This can eliminate the shortcoming of the flyback system with a large peak value of the secondary current, and the AC input voltage Vin can be directly converted into the DC output voltage Vout at high efficiency even when medium to high power is applied.

### <Individual ZVS Control>

Individual ZVS control executed by the switch driving apparatus 130 will next be described in detail with reference to the drawings.

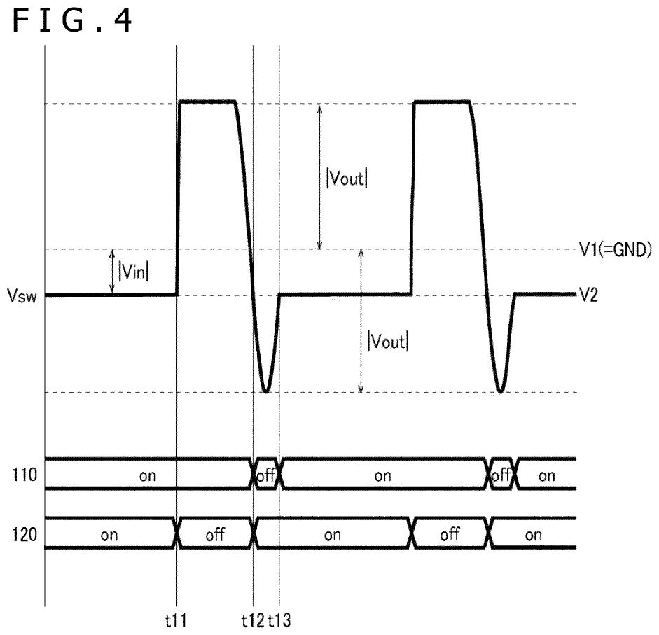

FIG. 4 illustrates a first example of the individual ZVS control (where Vin<0 (V1>V2) and |Vin| is relatively small), and FIG. 4 depicts the switch voltage Vsw and on/off states of the switch elements 110 and 120 from the top.

Both the switch elements 110 and 120 are turned on before time t11. In this case, a primary current flows in a current path from the first node of the AC power supply P (=application end of voltage V1) to the second node of the AC power supply P (=application end of voltage V2) through the primary winding 141 and the bidirectional switch X, and energy is stored in the primary winding 141. Note that the switch voltage Vsw coincides with the voltage V2 at this point.

Once predetermined energy is stored in the primary winding 141 at time t11, the switch driving apparatus 130 switches the bidirectional switch X from on to off. The switch driving apparatus 130 may turn off the bidirectional switch X when the switch driving apparatus 130 detects the passage of a predetermined time period from the on timing of the bidirectional switch X or when the switch driving apparatus 130 detects that the integral value of the primary current has reached a predetermined threshold.

In this case, the switch driving apparatus 130 does not turn off the switch elements 110 and 120 at the same time. The switch driving apparatus 130 turns off the switch element 120 including the reverse biased internal diode 122 (=element provided with reverse voltage) while keeping the switch element 110 including the forward biased internal diode 112 (=element provided with forward voltage) turned on.

Specifically, the switch driving apparatus 130 continues to output an on signal from the controller 133 to a control end of the switch element 110 through the driver 131 and outputs an off signal from the controller 133 to a control end of the switch element 120 through the driver 132.

Along with the rise in the switch voltage Vsw, the voltage between the drain and the source of the switch element 120 (=Vsw−V2) gradually rises while energy is stored in the internal capacitance 123 of the switch element 120, the stray capacitances C1 to C4 of the transformer 140, and the internal capacitances C5 of the diodes 161 and 162. Note that the switch voltage Vsw rises until the absolute value of the switch voltage Vsw coincides with the DC output voltage Vout.

The voltage between the ends of the secondary winding 142a magnetically coupled to the primary winding 141 of the transformer 140 also gradually increases in this case. Once the voltage between the ends of the secondary winding 142a becomes higher than the total voltage of the voltage between the ends of the capacitor 154 and the forward direction drop voltage of the diode 161, current flows from the secondary winding 142a to the capacitor 154 through the diode 161, and the capacitor 154 is charged.

Once all the energy stored in the transformer 140 is discharged to the capacitor 154, the switch voltage Vsw starts to fall due to the internal capacitance 123 of the switch element 120, the stray capacitances C1 to C4 of the transformer 140, and the internal capacitances C5 of the diodes 161 and 162, and the voltage between the drain and the source of the switch element 120 gradually falls.

At time t12, the switch voltage Vsw falls until the switch voltage Vsw coincides with the voltage V2. Once the voltage between the drain and the source of the switch element 120 becomes 0 V, the switch driving apparatus 130 at this timing turns on the switch element 120 and turns off the switch element 110 at the same time.

Specifically, the switch driving apparatus 130 outputs an off signal from the controller 133 to the control end of the switch element 110 through the driver 131 and outputs an on signal from the controller 133 to the control end of the switch element 120 through the driver 132.

In this case, the switch voltage Vsw falls to a potential lower than the voltage V2 due to the energy stored in the transformer 140. Hence, the voltage between the drain and the source of the switch element 110 (=V2−Vsw) rises, and a reverse voltage is applied to the switch element 110 (that is, the internal diode 112 of the switch element 110 is reverse biased).

However, when there is no more energy stored in the transformer 140, the switch voltage Vsw starts to rise due to the internal capacitance 113 of the switch element 110 and other capacitances, and the voltage between the drain and the source of the switch element 110 gradually falls.

At time t13, the switch voltage Vsw rises until the switch voltage Vsw coincides with the voltage V2. Once the voltage between the drain and the source of the switch element 110 becomes 0 V, the switch driving apparatus 130 at this timing turns on the switch element 110 while keeping the switch element 120 turned on.

Specifically, the switch driving apparatus 130 continues to output an on signal from the controller 133 to the control end of the switch element 120 through the driver 132 and outputs an on signal from the controller 133 to the control end of the switch element 110 through the driver 131.

In this way, to switch the bidirectional switch X from off to on in the first example of the individual ZVS control illustrated in FIG. 4, the switch driving apparatus 130 performs first ZVS control to turn on the turned-off switch element 120 at such a timing that the voltage between the ends of the switch element 120 becomes 0 V. The switch driving apparatus 130 then performs second ZVS control to turn off the switch element 110 at such a timing that the switch element 120 is turned on and to turn on the switch element 110 at such a timing that the voltage between the ends of the switch element 110 becomes 0 V.

The switching control can be repeated to individually turn on the switch elements 110 and 120 at such a timing that the charge is not stored in the respective internal capacitances 113 and 123 of the switch elements 110 and 120 during the on transition of the bidirectional switch X. Accordingly, the switching loss of each of the switch elements 110 and 120 can be as close to 0 as possible, and heat generation of the bidirectional switch X can be suppressed.

Note that the resonance energy of the primary winding 141 is released in a short period of time in FIG. 4. This can suppress the reduction in switching frequency at low input voltage. The switching current can be suppressed by suppression of the reduction in switching frequency, and the reduction in efficiency can also be suppressed. In addition, the transformer 140 can be downsized, and a smaller, highly efficient switching power supply 100 can be realized.

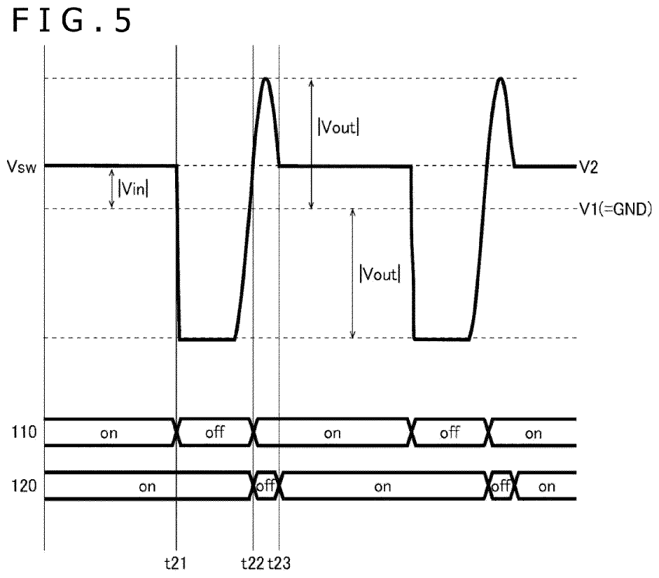

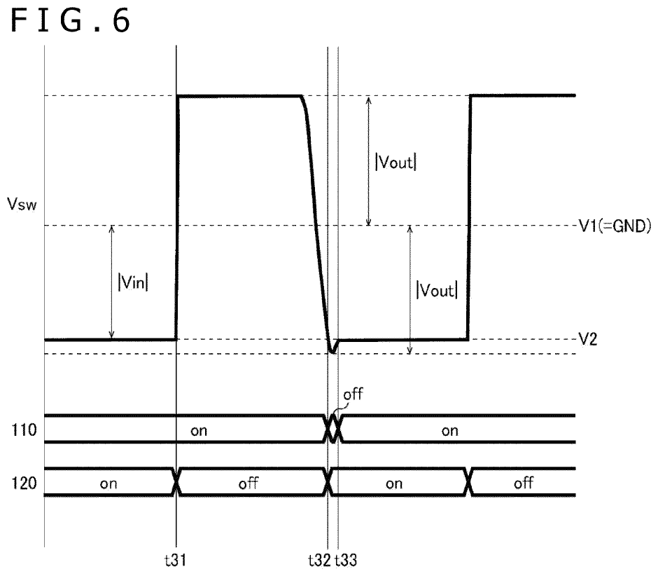

FIG. 5 illustrates a second example of the individual ZVS control (where Vin>0 (V1<V2) and |Vin| is relatively small), and FIG. 5 depicts the switch voltage Vsw and the on/off states of the switch elements 110 and 120 from the top.

Both the switch elements 110 and 120 are turned on before time t21. In this case, the primary current flows in a current path from the second node of the AC power supply P (=application end of voltage V2) to the first node of the AC power supply P (=application end of voltage V1) through the bidirectional switch X and the primary winding 141, and energy is stored in the primary winding 141. Note that the switch voltage Vsw coincides with the voltage V2 at this point.

Once predetermined energy is stored in the primary winding 141 at time t21, the switch driving apparatus 130 switches the bidirectional switch X from on to off. The switch driving apparatus 130 may turn off the bidirectional switch X when the switch driving apparatus 130 detects the passage of a predetermined time period from the on timing of the bidirectional switch X or when the switch driving apparatus 130 detects that the integral value of the primary current has reached a predetermined threshold, as also described above.

In this case, the switch driving apparatus 130 does not turn off the switch elements 110 and 120 at the same time. The switch driving apparatus 130 turns off the switch element 110 including the reverse biased internal diode 112 (=element provided with reverse voltage) while keeping the switch element 120 including the forward biased internal diode 122 (=element provided with forward voltage) turned on.

Specifically, the switch driving apparatus 130 continues to output an on signal from the controller 133 to the control end of the switch element 120 through the driver 132 and outputs an off signal from the controller 133 to the control end of the switch element 110 through the driver 131.

Along with the fall in the switch voltage Vsw, the voltage between the drain and the source of the switch element 110 (=V2−Vsw) gradually rises while energy is stored in the internal capacitance 113 of the switch element 110, the stray capacitances C1 to C4 of the transformer 140, and the internal capacitances C5 of the diodes 161 and 162. Note that the switch voltage Vsw falls until the absolute value of the switch voltage Vsw coincides with the DC output voltage Vout.

The voltage between the ends of the secondary winding 142b magnetically coupled to the primary winding 141 of the transformer 140 also gradually increases in this case. Once the voltage between the ends of the secondary winding 142b becomes higher than the total voltage of the voltage between the ends of the capacitor 154 and the forward direction drop voltage of the diode 162, the current flows from the secondary winding 142b to the capacitor 154 through the diode 162, and the capacitor 154 is charged.

Once all the energy stored in the transformer 140 is discharged to the capacitor 154, the switch voltage Vsw starts to rise due to the internal capacitance 113 of the switch element 110, the stray capacitances C1 to C4 of the transformer 140, and the internal capacitances C5 of the diodes 161 and 162, and the voltage between the drain and the source of the switch element 110 gradually falls.

At time t22, the switch voltage Vsw rises until the switch voltage Vsw coincides with the voltage V2. Once the voltage between the drain and the source of the switch element 110 becomes 0 V, the switch driving apparatus 130 at this timing turns on the switch element 110 and turns off the switch element 120 at the same time.

Specifically, the switch driving apparatus 130 outputs an on signal from the controller 133 to the control end of the switch element 110 through the driver 131 and outputs an off signal from the controller 133 to the control end of the switch element 120 through the driver 132.

In this case, the switch voltage Vsw rises to a potential higher than the voltage V2 due to the energy stored in the transformer 140. Accordingly, the voltage between the drain and the source of the switch element 120 (=Vsw−V2) rises, and a reverse voltage is applied to the switch element 120 (that is, the internal diode 122 of the switch element 120 is reverse biased).

However, when there is no more energy stored in the transformer 140, the switch voltage Vsw starts to fall due to the internal capacitance 123 of the switch element 120 and other capacitances, and the voltage between the drain and the source of the switch element 120 gradually falls.

At time t23, the switch voltage Vsw falls until the switch voltage Vsw coincides with the voltage V2. Once the voltage between the drain and the source of the switch element 120 becomes 0 V, the switch driving apparatus 130 at this timing turns on the switch element 120 while keeping the switch element 110 turned on.

Specifically, the switch driving apparatus 130 continues to output an on signal from the controller 133 to the control end of the switch element 110 through the driver 131 and outputs an on signal from the controller 133 to the control end of the switch element 120 through the driver 132.

In this way, to switch the bidirectional switch X from off to on in the second example of the individual ZVS control illustrated in FIG. 5, the switch driving apparatus 130 performs first ZVS control to turn on the turned-off switch element 110 at such a timing that the voltage between the ends of the switch element 110 becomes 0 V. The switch driving apparatus 130 then performs second ZVS control to turn off the switch element 120 at such a timing that the switch element 110 is turned on and to turn on the switch element 120 at such a timing that the voltage between the ends of the switch element 120 becomes 0 V.

The switching control can be repeated to individually turn on the switch elements 110 and 120 at such a timing that charge is not stored in the respective internal capacitances 113 and 123 of the switch elements 110 and 120 during the on transition of the bidirectional switch X. Accordingly, the switching loss of each of the switch elements 110 and 120 can be as close to 0 as possible, and heat generation of the bidirectional switch X can be suppressed.

Note that, in the switching power supply 100, the forward voltage and the reverse voltage may be applied to each of the switch elements 110 and 120 along with the resonance operation. Hence, the individual ZVS control described above is effective for realizing a highly efficient switching power supply 100.

The individual ZVS control is switched to one of the first example (FIG. 4) and the second example (FIG. 5) every time the positive or negative polarity of the AC input voltage Vin is inverted. However, the individual ZVS control can be applied without any problem even if the input voltage of the switching power supply 100 is fixed to a positive or negative voltage. For example, when the input voltage of the switching power supply 100 is fixed to a negative voltage (V1>V2), the individual ZVS control of the first example (FIG. 4) is typically carried out. Conversely, when the input voltage of the switching power supply 100 is fixed to a positive voltage (V1<V2), the individual ZVS control of the second example (FIG. 5) is typically carried out.

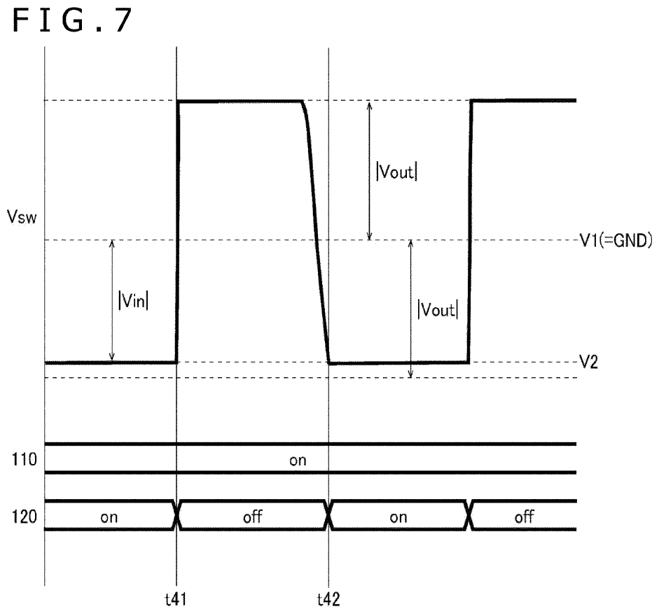

FIG. 6 illustrates a third example of the individual ZVS control (where Vin<0 (V1>V2) and |Vin| is relatively large), and FIG. 6 depicts the switch voltage Vsw and the on/off states of the switch elements 110 and 120 from the top.

The individual ZVS control of the third example is basically similar to the first example (FIG. 4), and the operation can be understood by replacing “time t11,” “time t12,” and “time t13” in the description above with “time t31,” “time t32,” and “time t33,” respectively.

However, it should be noted that, when |Vin| is relatively large, the reverse voltage application time period for the switch element 110 is significantly short as indicated by time t32 to t33, and the timing control becomes severe from the time that the switch element 110 is turned off to the time that the switch element 110 is turned on again.

Although the case of Vin<0 (V1>V2) is illustrated in FIG. 6, it is obvious that the control is similarly executed in the case of Vin>0 (V1<V2).

FIG. 7 illustrates a fourth example of the individual ZVS control (where second ZVS control is not carried out in the third example), and FIG. 7 depicts the switch voltage Vsw and the on/off states of the switch elements 110 and 120 from the top.

The individual ZVS control of the fourth example is characterized in that the second ZVS control (=ZVS control of switch element 110) is not carried out in view of the note described in the third example (FIG. 6). A series of operations including the part repeating the first example (FIG. 4) will be described.

Both the switch elements 110 and 120 are turned on before time t41. In this case, the primary current flows in a current path from the first node of the AC power supply P (=application end of voltage V1) to the second node of the AC power supply P (=application end of voltage V2) through the primary winding 141 and the bidirectional switch X, and energy is stored in the primary winding 141. Note that the switch voltage Vsw coincides with the voltage V2 at this point.

Once predetermined energy is stored in the primary winding 141 at time t41, the switch driving apparatus 130 switches the bidirectional switch X from on to off. The switch driving apparatus 130 may turn off the bidirectional switch X when the switch driving apparatus 130 detects the passage of a predetermined time period from the on timing of the bidirectional switch X or when the switch driving apparatus 130 detects that the integral value of the primary current has reached a predetermined threshold, as also described above.

In this case, the switch driving apparatus 130 does not turn off the switch elements 110 and 120 at the same time. The switch driving apparatus 130 turns off the switch element 120 including the reverse biased internal diode 122 (=element provided with reverse voltage) while keeping the switch element 110 including the forward biased internal diode 112 (=element provided with forward voltage) turned on.

Specifically, the switch driving apparatus 130 continues to output an on signal from the controller 133 to the control end of the switch element 110 through the driver 131 and outputs an off signal from the controller 133 to the control end of the switch element 120 through the driver 132.

Along with the rise in the switch voltage Vsw, the voltage between the drain and the source of the switch element 120 (=Vsw−V2) gradually rises while energy is stored in the internal capacitance 123 of the switch element 120, the stray capacitances C1 to C4 of the transformer 140, and the internal capacitances C5 of the diodes 161 and 162. Note that the switch voltage Vsw rises until the absolute value of the switch voltage Vsw coincides with the DC output voltage Vout.

The voltage between the ends of the secondary winding 142a magnetically coupled to the primary winding 141 of the transformer 140 also gradually increases in this case. Once the voltage between the ends of the secondary winding 142a becomes higher than the total voltage of the voltage between the ends of the capacitor 154 and the forward direction drop voltage of the diode 161, the current flows from the secondary winding 142a to the capacitor 154 through the diode 161, and the capacitor 154 is charged.

Once all the energy stored in the transformer 140 is discharged to the capacitor 154, the switch voltage Vsw starts to fall due to the internal capacitance 123 of the switch element 120, the stray capacitances C1 to C4 of the transformer 140, and the internal capacitances C5 of the diodes 161 and 162, and the voltage between the drain and the source of the switch element 120 gradually falls.

At time t42, the switch voltage Vsw falls until the switch voltage Vsw coincides with the voltage V2. Once the voltage between the drain and the source of the switch element 120 becomes 0 V, the switch driving apparatus 130 at this timing turns on the switch element 120 while keeping the switch element 110 turned on.

Specifically, the switch driving apparatus 130 continues to output an on signal from the controller 133 to the control end of the switch element 110 through the driver 131 and outputs an on signal from the controller 133 to the control end of the switch element 120 through the driver 132.

In this case, the energy stored in the transformer 140 is regenerated in the AC power supply P. Note that when there is no more energy in the transformer 140, the transformer 140 starts to store energy again.

As described above, the ZVS control (=second ZVS control) of the switch element 110 is eliminated in the individual ZVS control of the fourth example. The switch element 110 is kept turned on all the time, and only the high frequency switching (=first ZVS control) of the switch element 120 is carried out.

Accordingly, even when |Vin| is relatively large and the reverse voltage application time period for the switch element 110 is significantly short, heat generation of the bidirectional switch X can be suppressed without severe timing control.

Although not further illustrated, if Vin>0 (V1<V2), the switch element 120 is kept turned on all the time, and only the high frequency switching (=first ZVS control) of the switch element 110 is carried out.

In addition, the switch driving apparatus 130 can have a function of switching between performing and not performing the second ZVS control (that is, performing the individual ZVS control of the first to third examples (FIGS. 4 to 6) or performing the individual ZVS control of the fourth example (FIG. 7)) according to the AC input voltage Vin or a preset condition.

### Second Embodiment

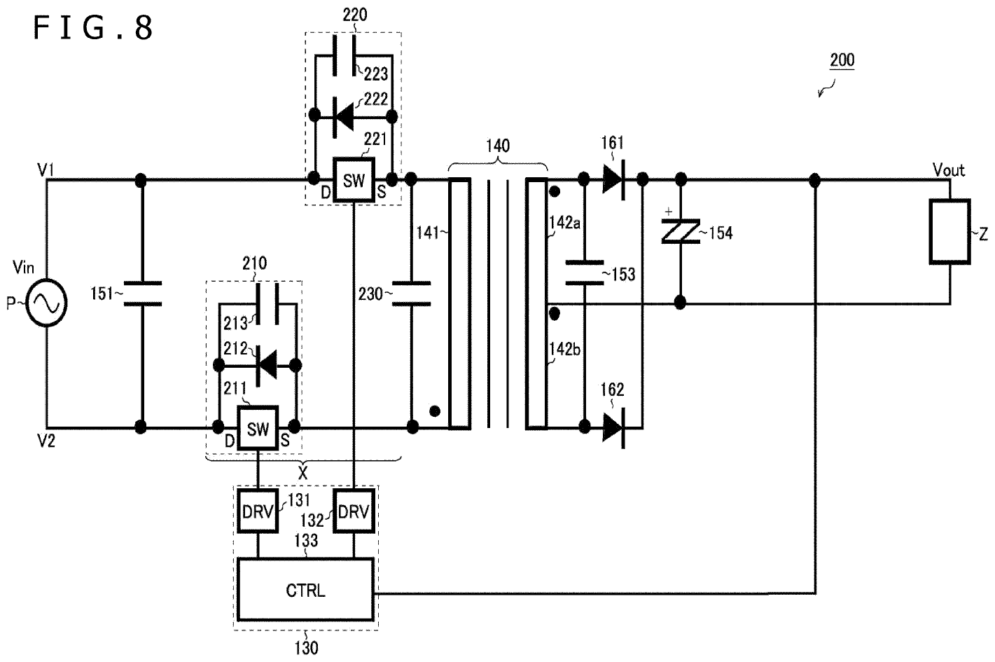

FIG. 8 illustrates the switching power supply according to a second embodiment. A switching power supply 200 of the present embodiment is based on the first embodiment (FIG. 1) but includes switch elements 210 and 220 and a capacitor 230 in place of the switch elements 110 and 120 and the capacitor 152. The following description will focus on the changed part.

The switch element 210 is connected to the second node of the AC power supply P (=application end of voltage V2) and the second input tap of the transformer 140 (=winding start end of primary winding 141) between them. Meanwhile, the switch element 220 is connected to the first node of the AC power supply P (=application end of voltage V1) and the first input tap of the transformer 140 (=winding finish end of primary winding 141) between them. That is, the primary winding 141 is connected to the switch element 210 and the switch element 220 between them.

Note that the switch elements 210 and 220 include switch function units 211 and 221 (transistor bodies) as well as internal diodes 212 and 222 and internal capacitances 213 and 223, respectively. In the case of FIG. 8, a cathode of the internal diode 212 and a first end of the internal capacitance 213 are connected to a drain D of the switch function unit 211. An anode of the internal diode 212 and a second end of the internal capacitance 213 are connected to a source S of the switch function unit 211. Meanwhile, a cathode of the internal diode 222 and a first end of the internal capacitance 223 are connected to a drain D of the switch function unit 221. An anode of the internal diode 222 and a second end of the internal capacitance 223 are connected to a source S of the switch function unit 221.

In this way, the switch elements 210 and 220 included in the bidirectional switch X are separately arranged across the primary winding 141.

Unlike the capacitor 152, the capacitor 230 is connected in series to the bidirectional switch X (=connected in parallel to the primary winding 141).

Note that the switching power supply 200 of the present embodiment can also carry out the individual ZVS control described so far (any one of the first to fourth examples) in the on/off drive of the bidirectional switch X, and the switching power supply 200 can attain effects similar to the effects described above.

### Third Embodiment

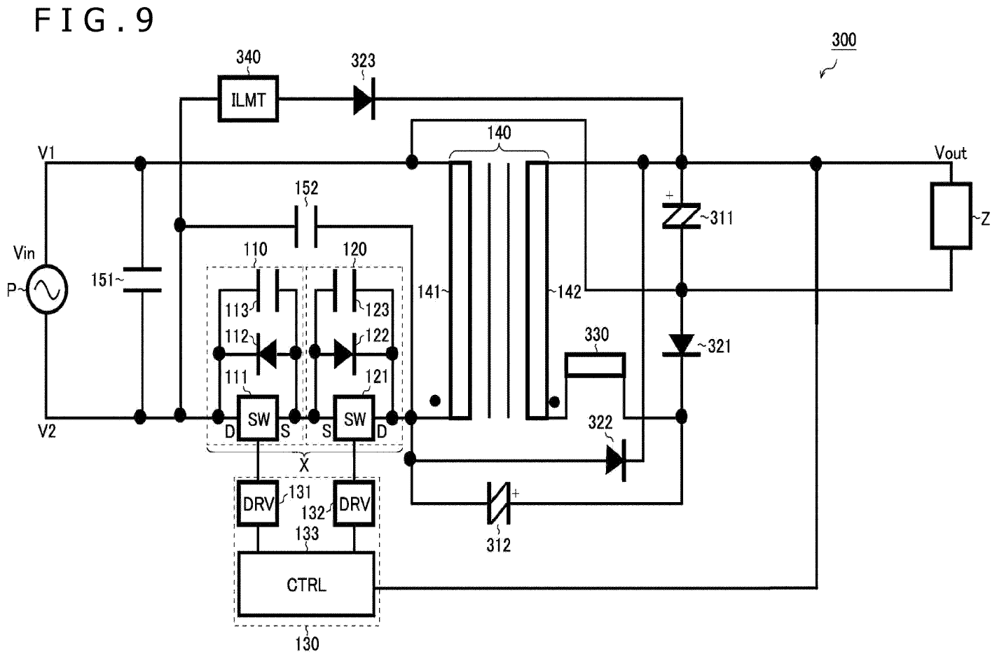

FIG. 9 illustrates the switching power supply according to a third embodiment. A switching power supply 300 of the present embodiment is based on the first embodiment (FIG. 1) but includes a secondary winding 142, capacitors 311 and 312, diodes 321 to 323, an auxiliary winding 330, and a current limiting element 340 in place of the secondary windings 142a and 142b, the capacitors 153 and 154, and the diodes 161 and 162. The following description will focus on the changed part.

The first output tap of the transformer 140 (=winding finish end of secondary winding 142) is connected, as an output end of the DC output voltage Vout, to the high potential end of the load Z. Note that the low potential end of the load Z is connected to the first input tap of the transformer 140 (=winding finish end of primary winding 141). The second output tap of the transformer 140 (=winding start end of secondary winding 142) is connected to a first end of the auxiliary winding 330.

The capacitor 311 is connected in parallel to the load Z. The capacitor 312 is connected to the second input tap of the transformer 140 (=winding start end of primary winding 141) and a second end of the auxiliary winding 330 between them.

An anode of the diode 321 is connected to the first input tap of the transformer 140. A cathode of the diode 321 is connected to the second end of the auxiliary winding 330. An anode of the diode 322 is connected to the second input tap of the transformer 140. A cathode of the diode 322 is connected to the first output tap of the transformer 140. An anode of the diode 323 is connected to the second end of the AC power supply P (=application end of voltage V2) through the current limiting element 340. A cathode of the diode 323 is connected to the first output tap of the transformer 140.

A basic operation of the switching power supply 300 will be described. When, for example, the AC input voltage Vin is positive (V1<V2), a limiting current flows in a current path from the second node of the AC power supply P (=application end of voltage V2) to the capacitor 312 through the current limiting element 340, the diode 323, the secondary winding 142, and the auxiliary winding 330, and the capacitor 312 is charged.

Once the bidirectional switch X is turned on, the primary current flows to the primary winding 141 of the transformer 140, and energy is stored. The bidirectional switch X is turned off once predetermined energy is stored. In this case, the voltages of the second input tap (=winding start end of primary winding 141) and the second output tap (=winding start end of secondary winding 142) of the transformer 140 gradually fall at substantially the same voltage drop rate. Accordingly, a short-circuit current does not flow to the capacitor 312.

Once the voltage applied to the second input tap of the transformer 140 becomes lower than the total voltage of the voltage between the ends of the capacitor 312 and the forward direction drop voltage of the diode 321, the current flows into the capacitor 312 through the diode 321, and the capacitor 312 is charged. The energy stored in the capacitor 312 is further used to charge the capacitor 311 through the auxiliary winding 330 and the secondary winding 142. Once all the energy of the transformer 140 is discharged to the capacitor 312, the bidirectional switch X is turned on again at an appropriate timing.

When the capacitors 311 and 312 are already charged and the AC input voltage Vin is negative (V1>V2), the primary current flows to the primary winding 141 of the transformer 140 once the bidirectional switch X is turned on, and energy is stored. The bidirectional switch X is turned off once predetermined energy is stored. In this case, the voltages of the second input tap (=winding start end of primary winding 141) and the second output tap (=winding start end of secondary winding 142) of the transformer 140 gradually rise at substantially the same voltage rise rate. Accordingly, a short-circuit current does not flow to the capacitor 312.

Once the voltage applied to the second input tap of the transformer 140 becomes higher than the total voltage of the voltage between the ends of the capacitor 311 and the forward direction drop voltage of the diode 322, the current flows into the capacitor 311 through the diode 322, and the capacitor 311 is charged. Once all the energy of the transformer 140 is discharged to the capacitor 311, the bidirectional switch X is turned on again at an appropriate timing.

The switching power supply 300 of the present embodiment can also carry out the individual ZVS control described so far (any one of the first to fourth examples) in the on/off drive of the bidirectional switch X, and the switching power supply 300 can attain effects similar to the effects described above.

### Fourth Embodiment

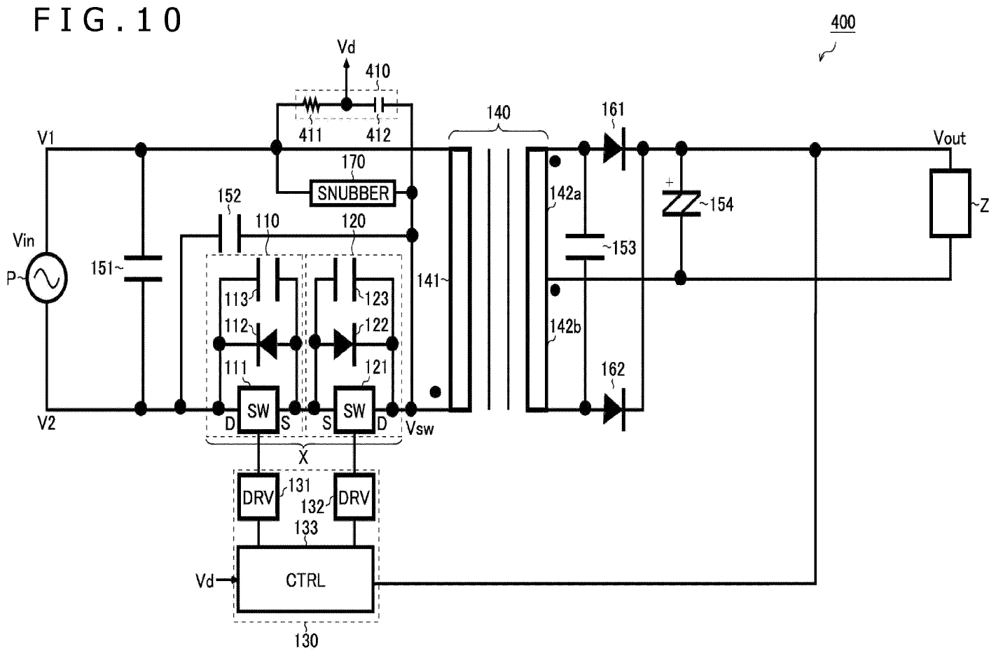

FIG. 10 illustrates the switching power supply according to a fourth embodiment. A switching power supply 400 of the present embodiment is based on the first embodiment (FIG. 1) but further includes a differential circuit 410 as a section for detecting zero cross timing that may be necessary for the individual ZVS control.

The differential circuit 410 includes a resistance 411 and a capacitor 412, and the differential circuit 410 differentiates the switch voltage Vsw appearing at one end of the bidirectional switch X and generates a differential voltage Vd. A first end of the resistance 411 is connected to the first input tap of the transformer 140 (=winding finish end of primary winding 141). A second end of the resistance 411 and a first end of the capacitor 412 are both connected to an output end of the differential voltage Vd. A second end of the capacitor 412 is connected to the second input tap of the transformer 140 (=winding start end of primary winding 141).

The switch driving apparatus 130 performs the individual ZVS control of the switch elements 110 and 120, according to the differential voltage Vd. For example, the switch driving apparatus 130 determines the on/off timing of the switch elements 110 and 120, according to a comparison result of the differential voltage Vd and predetermined threshold voltages VH and VL (where VL<0<VH). This will be described in detail below with reference to the drawings.

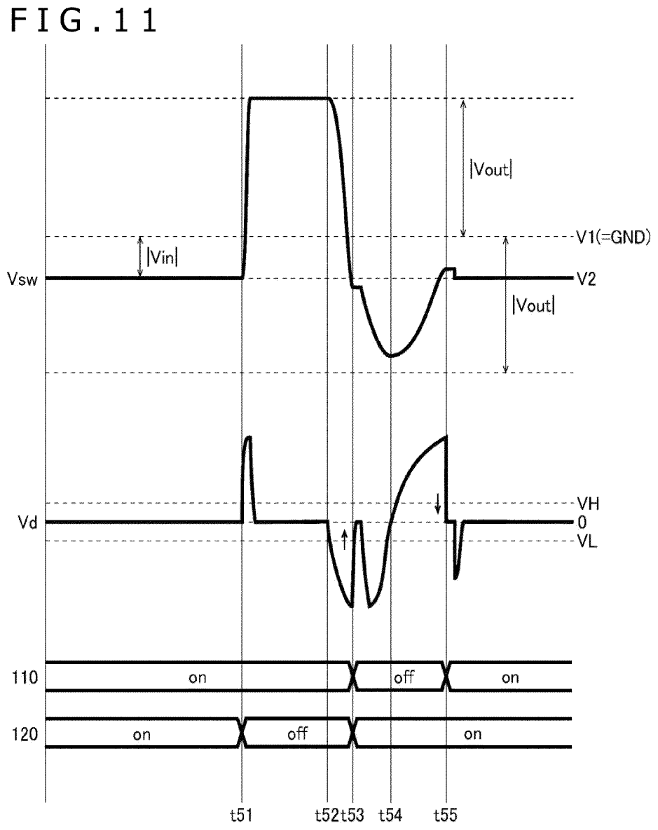

FIG. 11 illustrates a fifth example of the individual ZVS control (ZVS control based on differential voltage Vd), and FIG. 11 depicts the switch voltage Vsw, the differential voltage Vd, and the on/off states of the switch elements 110 and 120 from the top. A series of operations including the part repeating the first example (FIG. 4) will be described, particularly, with a focus on the differential voltage Vd.

Both the switch elements 110 and 120 are turned on before time t51. In this case, the primary current flows in a current path from the first node of the AC power supply P (=application end of voltage V1) to the second node of the AC power supply P (=application end of voltage V2) through the primary winding 141 and the bidirectional switch X, and energy is stored in the primary winding 141. Note that the switch voltage Vsw coincides with the voltage V2 at this point. The differential voltage Vd is 0 V.

Once predetermined energy is stored in the primary winding 141 at time t51, the switch driving apparatus 130 switches the bidirectional switch X from on to off. The switch driving apparatus 130 may turn off the bidirectional switch X when the switch driving apparatus 130 detects the passage of a predetermined time period from the on timing of the bidirectional switch X or when the switch driving apparatus 130 detects that the integral value of the primary current has reached a predetermined threshold, as also described above.

In this case, the switch driving apparatus 130 does not turn off the switch elements 110 and 120 at the same time. The switch driving apparatus 130 turns off the switch element 120 including the reverse biased internal diode 122 (=element provided with reverse voltage) while keeping the switch element 110 including the forward biased internal diode 112 (=element provided with forward voltage) turned on.

Specifically, the switch driving apparatus 130 continues to output an on signal from the controller 133 to the control end of the switch element 110 through the driver 131 and outputs an off signal from the controller 133 to the control end of the switch element 120 through the driver 132.

Along with the rise in the switch voltage Vsw, the voltage between the drain and the source of the switch element 120 (=Vsw−V2) gradually rises while energy is stored in the internal capacitance 123 of the switch element 120, the stray capacitances C1 to C4 of the transformer 140, and the internal capacitances C5 of the diodes 161 and 162. Note that the switch voltage Vsw rises until the absolute value of the switch voltage Vsw coincides with the DC output voltage Vout. In this case, the differential voltage Vd temporarily exceeds the threshold voltage VH and then falls below the threshold voltage VH again.

The voltage between the ends of the secondary winding 142a coupled to the primary winding 141 of the transformer 140 also gradually increases in this case. Once the voltage between the ends of the secondary winding 142a becomes higher than the total voltage of the voltage between the ends of the capacitor 154 and the forward direction drop voltage of the diode 161, the current flows from the secondary winding 142a to the capacitor 154 through the diode 161, and the capacitor 154 is charged.

Once all the energy stored in the transformer 140 is discharged to the capacitor 154 at time t52, the switch voltage Vsw starts to fall due to the internal capacitance 123 of the switch element 120, the stray capacitances C1 to C4 of the transformer 140, and the internal capacitances C5 of the diodes 161 and 162, and the voltage between the drain and the source of the switch element 120 gradually falls. In this case, the differential voltage Vd falls below the threshold voltage VL.

At time t53, the switch voltage Vsw falls until the switch voltage Vsw coincides with the voltage V2. Once the voltage between the drain and the source of the switch element 120 becomes 0 V, the switch driving apparatus 130 at this timing turns on the switch element 120 and turns off the switch element 110 at the same time.

Specifically, the switch driving apparatus 130 outputs an off signal from the controller 133 to the control end of the switch element 110 through the driver 131 and outputs an on signal from the controller 133 to the control end of the switch element 120 through the driver 132.

Note that, at time t53, the switch voltage Vsw is clamped to a voltage equivalent to the voltage V2 minus the forward direction drop voltage of the internal diode 122, and the differential voltage Vd sharply rises from a negative value (<VL) to 0 V. Hence, the switch driving apparatus 130 preferably turns on the switch element 120 at such a timing that the differential voltage Vd exceeds the threshold voltage VL and turns off the switch element 110 at the same time. The differential voltage Vd also exceeds the threshold voltage VL at times other than time t53, but such timings can entirely be ignored or masked.

In this case, the switch voltage Vsw falls to a potential lower than the voltage V2 due to the energy stored in the transformer 140. The voltage between the drain and the source of the switch element 110 (=V2−Vsw) rises, and a reverse voltage is applied to the switch element 110 (that is, internal diode 112 of switch element 110 is reverse biased). Accordingly, the differential voltage Vd falls below the threshold voltage VL again.

However, when there is no more energy stored in the transformer 140 at time t54, the switch voltage Vsw starts to rise due to the internal capacitance 113 of the switch element 110 and other capacitances, and the voltage between the drain and the source of the switch element 110 gradually falls. In this case, the differential voltage Vd rises from a negative value (<VL) to a positive value (>VH) through 0 V.

At time t55, the switch voltage Vsw rises until the switch voltage Vsw coincides with the voltage V2. Once the voltage between the drain and the source of the switch element 110 becomes 0 V, the switch driving apparatus 130 at this timing turns on the switch element 110 while keeping the switch element 120 turned on.

Specifically, the switch driving apparatus 130 continues to output an on signal from the controller 133 to the control end of the switch element 120 through the driver 132 and outputs an on signal from the controller 133 to the control end of the switch element 110 through the driver 131.

Note that at time t55, the switch voltage Vsw is clamped to a voltage equivalent to the voltage V2 plus the forward direction drop voltage of the internal diode 112, and the differential voltage Vd sharply falls from a positive value (>VH) to 0 V. Hence, the switch driving apparatus 130 preferably turns on the switch element 110 at such a timing that the differential voltage Vd falls below the threshold voltage VH. The differential voltage Vd also falls below the threshold voltage VH at times other than time t55, but such timings can entirely be ignored or masked.

In this way, to switch the bidirectional switch X from off to on, the switch driving apparatus 130 performs first ZVS control to turn on the turned-off switch element 120 at such a timing that the voltage between the ends of the switch element 120 becomes 0 V. The switch driving apparatus 130 then performs second ZVS control to turn off the switch element 110 at such a timing that the switch element 120 is turned on and to turn on the switch element 110 at such a timing that the voltage between the ends of the switch element 110 becomes 0 V.

The switching control can be repeated to individually turn on the switch elements 110 and 120 at such a timing that charge is not stored in the respective internal capacitances 113 and 123 of the switch elements 110 and 120 during the on transition of the bidirectional switch X. Accordingly, the switching loss of each of the switch elements 110 and 120 can be reduced, and heat generation of the bidirectional switch X can be suppressed.

Although the example of performing the individual ZVS control according to the differential voltage Vd has been illustrated in the present embodiment, the differential processing is a mere example of processing the switch voltage Vsw, and there can be various modifications. That is, the differential circuit 410 is a specific example of a voltage detection circuit that detects the switch voltage Vsw, and the processing method of the switch voltage Vsw does not matter as long as the individual ZVS control can be performed according to the switch voltage Vsw.

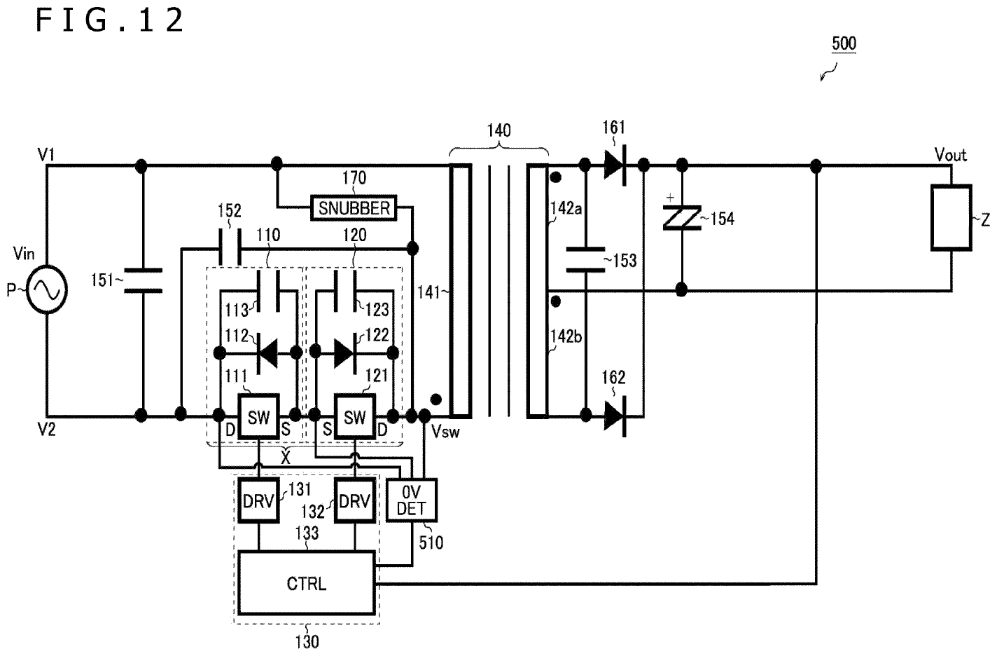

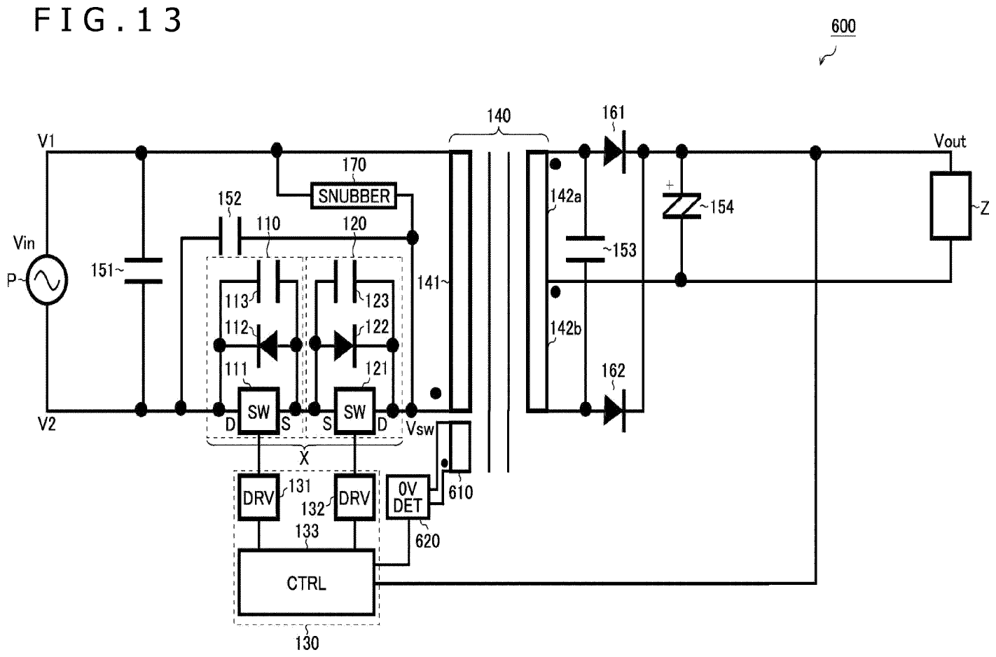

Obviously, the detection method of the zero cross timing is not limited to the methods described above, in any way. A fifth embodiment (FIG. 12) and a sixth embodiment (FIG. 13) will be illustrated below as examples to propose other zero cross detection methods.

### Fifth Embodiment

FIG. 12 illustrates the switching power supply according to a fifth embodiment. A switching power supply 500 of the present embodiment is based on the first embodiment (FIG. 1) but further includes a zero-voltage detection circuit 510 as a section for detecting the zero cross timing that may be necessary for the individual ZVS control.

The zero-voltage detection circuit 510 detects that the voltages between the drains and the sources of the switch elements 110 and 120 (or divided voltages of the voltages) have become 0 V and outputs the detection results to the controller 133. This can realize the individual ZVS. Particularly, the zero-voltage detection circuit 510 can easily be provided in an integrated circuit.

### Sixth Embodiment

FIG. 13 illustrates the switching power supply according to a sixth embodiment. A switching power supply 600 of the present embodiment is based on the first embodiment (FIG. 1) but further includes an auxiliary winding 610 and a zero-voltage detection circuit 620 as a section for detecting the zero cross timing that may be necessary for the individual ZVS control.

Note that the auxiliary winding 610 is magnetically coupled to the primary winding 141 and the secondary winding 142. The zero-voltage detection circuit 620 detects the induced voltage generated between ends of the auxiliary winding 610 and outputs the detection result to the controller 133. This can realize the individual ZVS.

The fourth embodiment (FIG. 10), the fifth embodiment (FIG. 12), and the sixth embodiment (FIG. 13) can be combined and carried out as long as there is no contradiction.

### Seventh Embodiment

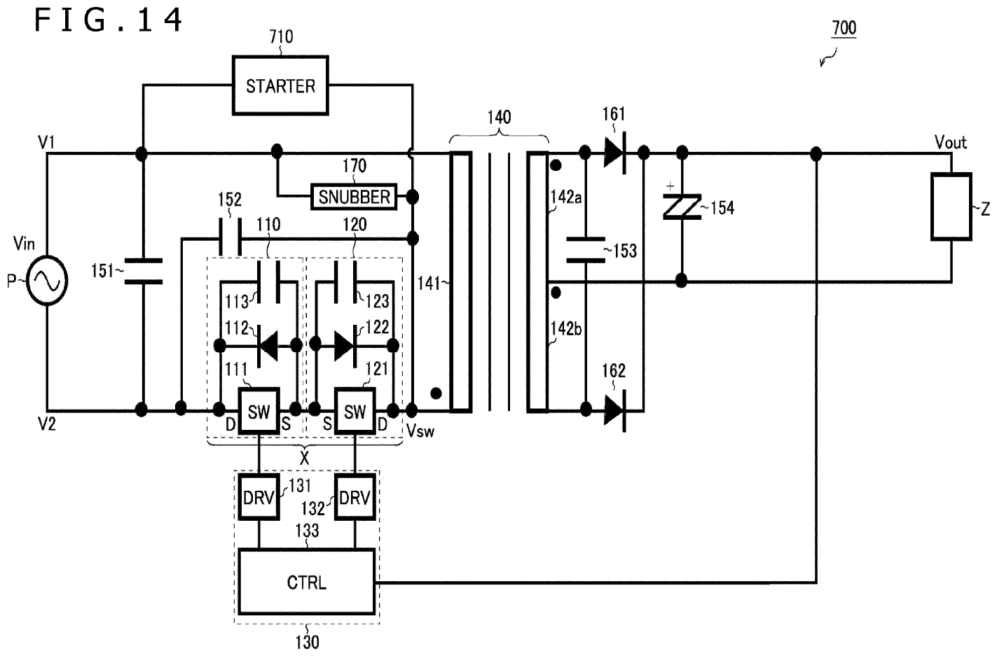

FIG. 14 illustrates the switching power supply according to a seventh embodiment. A switching power supply 700 of the present embodiment is based on the first embodiment (FIG. 1) but further includes a starting circuit 710. The starting circuit 710 is connected to the ends of the primary winding 141, and the starting circuit 710 charges the capacitor 154 in advance at the start of the switching power supply 700. According to the present embodiment, the switching power supply 700 can stably and surely be started.

### Eighth Embodiment

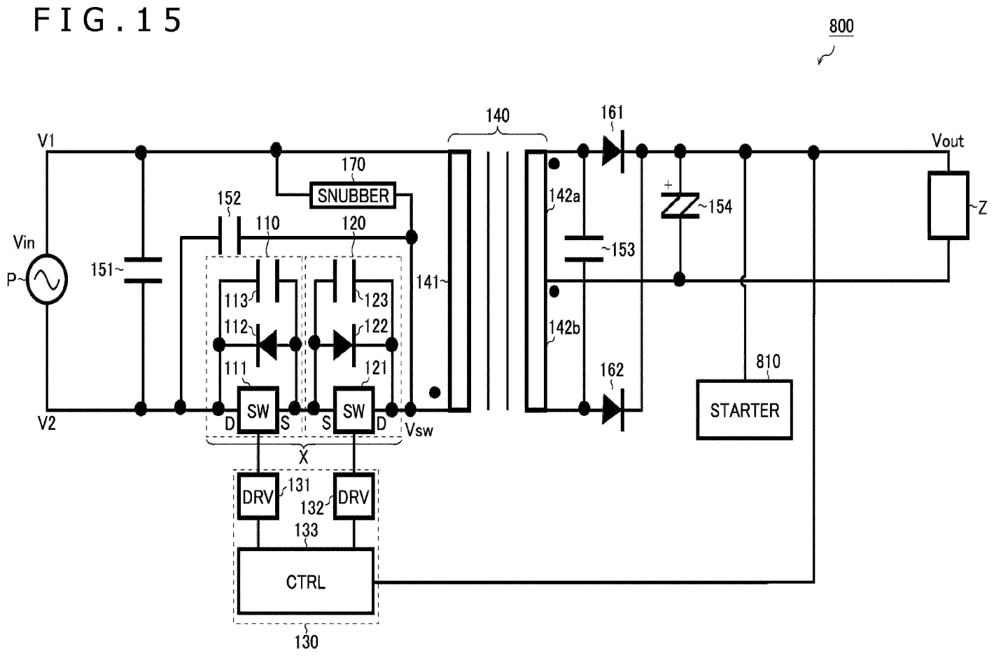

FIG. 15 illustrates the switching power supply according to an eighth embodiment. A switching power supply 800 of the present embodiment is based on the first embodiment (FIG. 1) but further includes a starting circuit 810. The starting circuit 810 is directly connected to the capacitor 154 of the secondary circuit system, and the starting circuit 810 charges the capacitor 154 in advance at the start of the switching power supply 800. According to the present embodiment, the switching power supply 800 can stably and surely be started.

### Ninth Embodiment

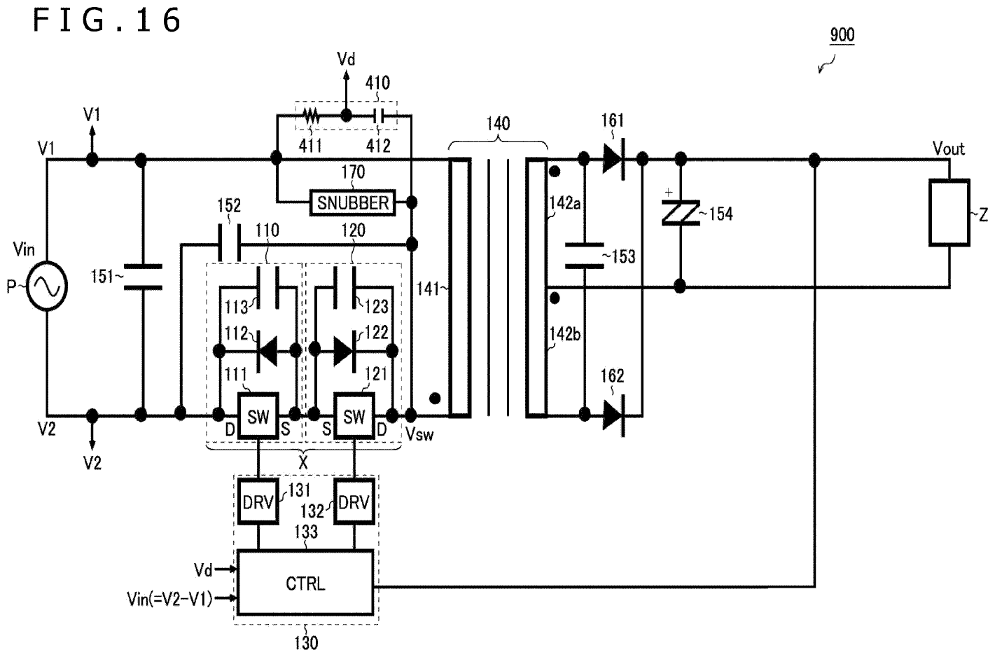

FIG. 16 illustrates the switching power supply according to a ninth embodiment. A switching power supply 900 of the present embodiment is based on the fourth embodiment (FIG. 10) but further has a function of monitoring, by the switch driving apparatus 130 (particularly, controller 133), the magnitude of the AC input voltage Vin (=V2−V1) along with the differential voltage Vd to control the drive of the bidirectional switch X according to the monitoring result. The technical meaning of adding the function will be described in detail later.

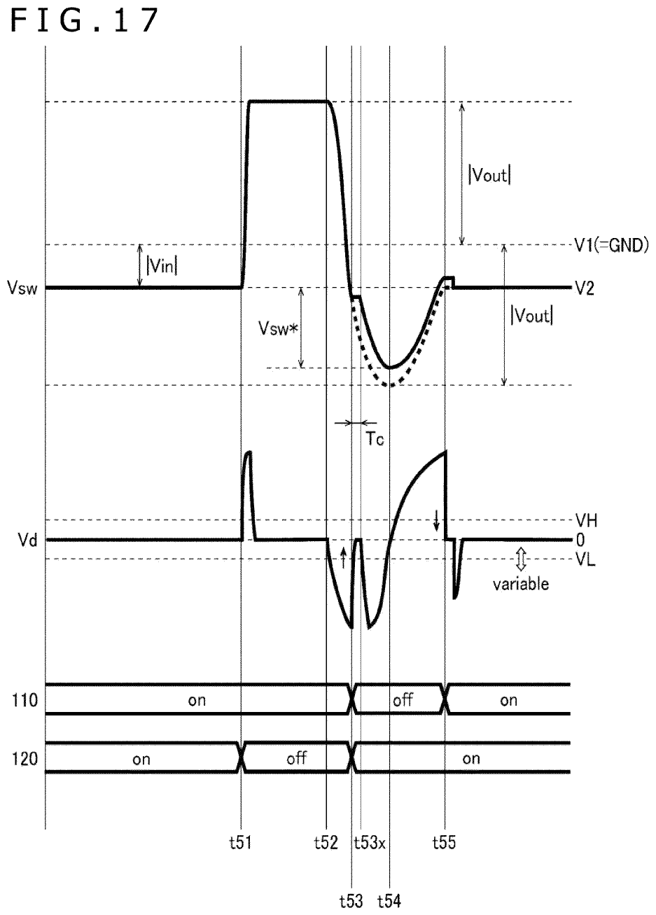

FIG. 17 is a diagram for describing a reduction in efficiency caused by the clamp operation at the zero cross timing. The content of FIG. 17 is basically the same as the content of FIG. 11. FIG. 17 further demonstrates a clamp period Tc (=time t53 to t53x) at the zero cross timing and depicts a dashed line indicating an ideal waveform of the switch voltage Vsw (that is, waveform with Tc=0).

As described in FIG. 11, the switch driving apparatus 130 (particularly, controller 133) determines the on/off timing (see time t53 and t55) of each of the switch elements 110 and 120 according to the comparison results of the differential voltage Vd and the threshold voltages VH and VL.

By the way, the clamp period Tc (=time t53 to t53x) of FIG. 17 corresponds to a period in which the switch voltage Vsw is clamped to the voltage equivalent to the voltage V2 minus the forward direction drop voltage of the internal diode 122. The energy returns toward the input side in the clamp period Tc. As a result, an amount of descent Vsw* of the switch voltage Vsw (=difference between lower peak value of switch voltage Vsw (<V2) and voltage V2) becomes smaller than an ideal waveform, and the energy that can be sent into the output side decreases accordingly. This reduces the efficiency.

Although the case of Vin<0 (V1>V2) is illustrated in FIG. 17, the efficiency may also be reduced by the clamp operation for basically the similar reason in the case of Vin>0 (V1<V2).

Hence, to shorten the clamp period Tc, the switching power supply 900 of the present embodiment has a function of monitoring, by the switch driving apparatus 130 (particularly, controller 133), the magnitude (=positive or negative, and absolute value) of the AC input voltage Vin (=V2−V1) along with the differential voltage Vd to control the drive of the bidirectional switch X (including adjustment process of threshold voltages VH and VL) according to the monitoring result.

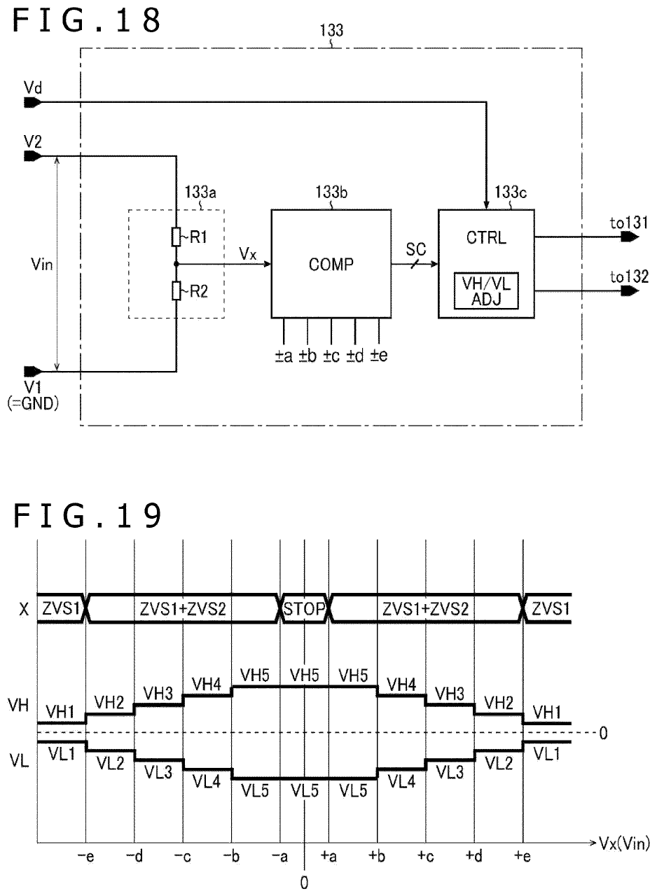

FIG. 18 illustrates a configuration example of main parts of the controller 133. The controller 133 of the present configuration example includes a voltage dividing unit 133a, a comparison unit 133b, and a control unit 133c.

The voltage dividing unit 133a includes resistances R1 and R2 connected in series between the application end of the voltage V2 and the application end of the voltage V1 (=GND), and the voltage dividing unit 133a outputs, from a connection node between the resistances R1 and R2, a divided voltage Vx corresponding to the AC input voltage Vin.

The comparison unit 133b compares the divided voltage Vx and predetermined threshold voltages (±a, ±b, ±c, ±d, and ±e in FIG. 18, where 0<|a|<|b|<|c|<|d|<|e|) and outputs a plurality of comparison signals SC. Note that the number (types) of threshold voltages compared with the divided voltage Vx is not limited to this. An amplifier that generates an error signal ERR corresponding to a difference (=Vref−Vx) between the divided voltage Vx and a predetermined reference voltage Vref may be used in place of the comparison unit 133b (comparator).

The control unit 133c controls the drive of the drivers 131 and 132 according to the comparison signals SC. For example, the control unit 133c uses a logical combination of a plurality of comparison signals SC to determine the magnitude (=positive or negative, and absolute value) of the AC input voltage Vin and executes various types of internal control (such as adjustment process of threshold voltages VH and VL, switching stop process of bidirectional switch X, and enabling process of second ZVS control, described in detail later) according to the determination result.

FIG. 19 illustrates an internal control example of the controller 133, and FIG. 19 depicts operation modes of the bidirectional switch X and the threshold voltages VH and VL from the top. Note that the horizontal axis of FIG. 19 represents the magnitude of the divided voltage Vx (as well as AC input voltage Vin).

For possible voltage values VH1 to VH5 of the positive threshold voltage VH (>0) in the following description, |VH1|<|VH2|<|VH3|<|VH4|<|VH5| holds. For possible voltage values VL1 to VL5 of the negative threshold voltage VL (<0), |VL1|<|VL2|<|VL3|<|VL4|<|VL5| holds.

In addition, |VH1|=|VL1|, |VH2|=|VL2|, |VH3|=|VL3|, |VH4|=|VL4|, and |VH5|=|VL5| may hold.

The user may be able to optionally set the possible voltage values VH1 to VH5 of the positive threshold voltage VH and the possible voltage values VL1 to VL5 of the negative threshold voltage VL.

When Vx<−e, the threshold voltage VH is set to the voltage value VH1, and the threshold voltage VL is set to the voltage value VL1, for example.

When −e<Vx<−d, the threshold voltage VH is set to the voltage value VH2, and the threshold voltage VL is set to the voltage value VL2, for example.

When −d<Vx<−c, the threshold voltage VH is set to the voltage value VH3, and the threshold voltage VL is set to the voltage value VL3, for example.

When −c<Vx<−b, the threshold voltage VH is set to the voltage value VH4, and the threshold voltage VL is set to the voltage value VL4, for example.

When −b<Vx<+b, the threshold voltage VH is set to the voltage value VH5, and the threshold voltage VL is set to the voltage value VL5, for example. However, when −a<Vx<+a, the bidirectional switch X enters a stop mode STOP (described in detail later), and the voltage values of the threshold voltages VH and VL do not matter.

When +b<Vx<+c, the threshold voltage VH is set to the voltage value VH4, and the threshold voltage VL is set to the voltage value VL4, for example.

When +c<Vx<+d, the threshold voltage VH is set to the voltage value VH3, and the threshold voltage VL is set to the voltage value VL3, for example.

When +d<Vx<+e, the threshold voltage VH is set to the voltage value VH2, and the threshold voltage VL is set to the voltage value VL2, for example.

When +d<Vx, the threshold voltage VH is set to the voltage value VH1, and the threshold voltage VL is set to the voltage value VL1, for example.

In this way, the switch driving apparatus 130 (particularly, controller 133) adjusts the threshold voltages VH and VL according to the magnitude (=positive or negative, and absolute value) of the AC input voltage Vin.

More specifically, the smaller the absolute value of the AC input voltage Vin, the larger the absolute values of the threshold voltages VH and VL set by the switch driving apparatus 130 (particularly, controller 133) to quicken the cross timing of the differential voltage Vd and the threshold voltages VH and VL.

An example of the case of Vin<0 (V1>V2) will be illustrated to describe the adjustment operation of the threshold voltage VL with reference to FIG. 17. In this case, the larger the absolute value of the AC input voltage Vin, the smaller the amount of descent Vsw* of the switch voltage Vsw. The amount of change of the differential voltage Vd (=lower peak value of differential voltage Vd) also becomes smaller.

Hence, unless the absolute value of the threshold voltage VL is set to a sufficiently small value, the differential voltage Vd does not fall below the threshold voltage VL, and the detection of the change timing of the differential voltage Vd (=timing that the differential voltage Vd fallen below the threshold voltage VL exceeds the threshold voltage VL again) may be missed out.

On the other hand, the smaller the absolute value of the AC input voltage Vin, the larger the amount of descent Vsw* of the switch voltage Vsw. The amount of change of the differential voltage Vd (=lower peak of differential voltage Vd) also becomes larger. The absolute value of the threshold voltage VL can be set to a large value within a range that allows detection of the change timing of the differential voltage Vd. This can quicken the cross timing of the differential voltage Vd and the threshold voltage VL and shorten the clamp period Tc.

The energy returned to the input side is reduced when the clamp period Tc is shortened. As a result, the amount of descent Vsw* of the switch voltage Vsw becomes closer to the ideal waveform, and this increases the energy that can be sent into the output side. Accordingly, the efficiency can be improved.

Although the clamp period Tc is significantly short from the start, a delay of several dozen ns here genuinely affects the amount of descent Vsw* (as well as efficiency) of the switch voltage Vsw. The improvement in efficiency is several tenths of 0.1% to 0.2%, and the improvement effect is seemingly small. However, the efficiency of the switching power supply in recent years has already reached over 99%, and a further improvement in efficiency is demanded. In view of this, it can be understood that the improvement of several tenths of 1% makes a very big impact.

By the adoption of the topology of the circuit proposed in the present embodiment, parts and compositions sold everywhere can be used to easily provide highly efficient AC/DC converter and isolated power supply.

Shortening the clamp period Tc makes the amount of descent Vsw* of the switch voltage Vsw large even when the AC input voltage Vin is large. This increases the range of the AC input voltage Vin that allows correct detection of the change timing of the differential voltage Vd.

As is apparent from the description, the adjustment process of the threshold voltage VL contributes to the shortening of the clamp period Tc if Vin<0 (V1>V2), and therefore, the threshold voltage VH may be set to a fixed value (for example, voltage value VH1).

On the contrary, the adjustment process of the threshold voltage VH contributes to the shortening of the clamp period Tc if Vin>0 (V1<V2), and hence, the threshold voltage VL may be set to a fixed value (for example, voltage value VL1), although not further illustrated.

Other than the method of using a comparator to adjust the threshold voltages VH and VL in stages as illustrated in FIG. 19, a method of using an amplifier to successively adjust the threshold voltages VH and VL may also be adopted.

Although the threshold voltages VH and VL are adjusted according to the magnitude of the AC input voltage Vin in the example described above, the threshold voltages VH and VL can be adjusted according to the waveform (dullness) of the differential voltage Vd in another example.

For example, the switch driving apparatus 130 (particularly, controller 133) preferably increases the absolute values of the threshold voltages VH and VL such that the duller the waveform of the differential voltage Vd is, the earlier the cross timing of the differential voltage Vd and the threshold voltages VH and VL becomes.

Note that, for example, the peak value of the differential voltage Vd, the time period from the zero value to the peak value, or the slope at the start of change in the differential voltage Vd can be detected as information related to the waveform (dullness) of the differential voltage Vd.

Particularly, both the magnitude of the AC input voltage Vin and the waveform (dullness) of the differential voltage Vd can be taken into account to adjust the threshold voltages VH and VL in the actual machine. For example, although the absolute values of the threshold voltages VH and VL should be lowered when the AC input voltage Vin is large, the absolute values of the threshold voltages VH and VL should not be lowered if the waveform of the differential voltage Vd is significantly dull. Therefore, the balance between them may need to be taken into account to adjust the threshold voltages VH and VL.

In any case, to shorten the clamp period Tc, it is important to appropriately adjust the threshold voltages VH and VL according to at least one of the magnitude of the AC input voltage Vin and the waveform of the differential voltage Vd, instead of setting the threshold voltages VH and VL to fixed values.

Operation modes of the bidirectional switch X illustrated in the upper part of FIG. 19 will next be described. In a first input voltage range (−e<Vin<−a and +a<Vin<+e), the bidirectional switch X enters an operation mode [ZVS1+ZVS2] of performing both the first ZVS control and the second ZVS control (see FIGS. 4, 5, and 6, and other figures).

In a second input voltage range (Vin<−e and +e<Vin), the bidirectional switch X enters an operation mode [ZVS1] of performing only the first ZVS control (see FIG. 7 and other figures). That is, the switch driving apparatus 130 (particularly, controller 133) shifts to the operation mode [ZVS1] of turning on/off one of the switch elements 110 and 120 while keeping the other turned on when the absolute value of the AC input voltage Vin is larger than a predetermined upper value (e in FIG. 19). This can suppress heat generation of the bidirectional switch X without severe timing control as also described above.

In a third input voltage range (−a<Vin<+a), the bidirectional switch X enters a stop mode [STOP] of stopping the drive. That is, the switch driving apparatus 130 (particularly, controller 133) shifts to the stop mode [STOP] of turning off both the switch elements 110 and 120 when the absolute value of the AC input voltage Vin is smaller than a predetermined lower limit (a in FIG. 19). In this way, the drive of the bidirectional switch X is stopped in an input voltage range in which sufficient excitation may not be expected even if the bidirectional switch X is driven. This can reduce the switching loss of each of the switch elements 110 and 120 and improve the efficiency.

### Tenth Embodiment

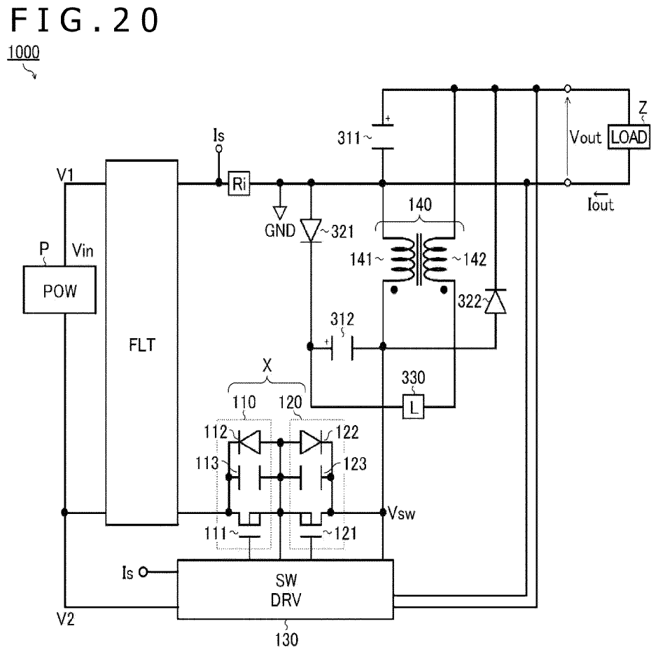

FIG. 20 illustrates the switching power supply according to a tenth embodiment. A switching power supply 1000 of the present embodiment is based on the third embodiment (FIG. 9), with a little change from the third embodiment. As illustrated in FIG. 20, the switching power supply 1000 of the present embodiment is provided with a filter FLT between the AC power supply P and the bidirectional switch X. The filter FLT may include the capacitor 151.

The switching power supply 1000 of the present embodiment includes a resistance Ri connected in series to the primary winding 141, and a current detection signal Is is extracted from one end of the resistance Ri. The switch driving apparatus 130 receives the current detection signal Is. The switch driving apparatus 130 has what is generally called an overcurrent protection function that is a function of stopping the on/off drive of the bidirectional switch X when the primary current flowing through the primary winding 141 is larger than an upper limit.

The switch driving apparatus 130 also receives an output feedback signal corresponding to the DC output voltage Vout. The switch driving apparatus 130 also has what is generally called an overvoltage prevention function that is a function of stopping the on/off drive of the bidirectional switch X when the DC output voltage Vout is higher than an upper limit.

Although the capacitor 152 and the current limiting element 340 of FIG. 9 are not illustrated in the switching power supply 1000 of the present embodiment, whether or not to exclude them can be determined optionally.

Next, the individual ZVS control in the switching power supply 1000 of the present embodiment will be described again with reference to the current path in each phase.

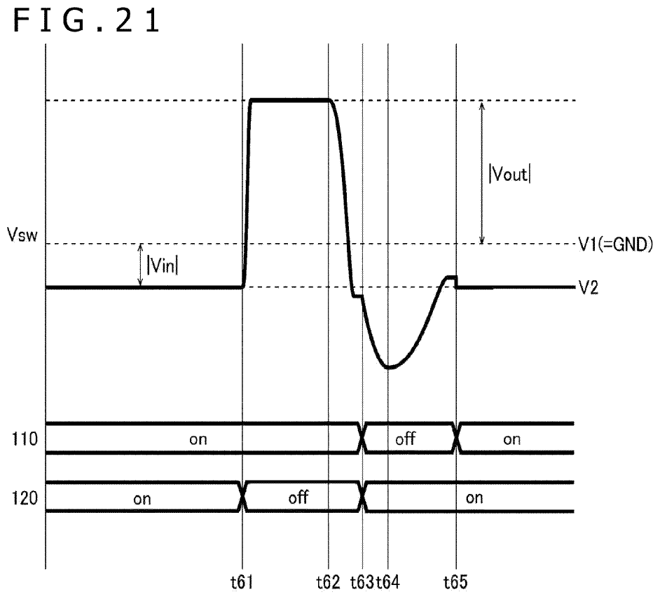

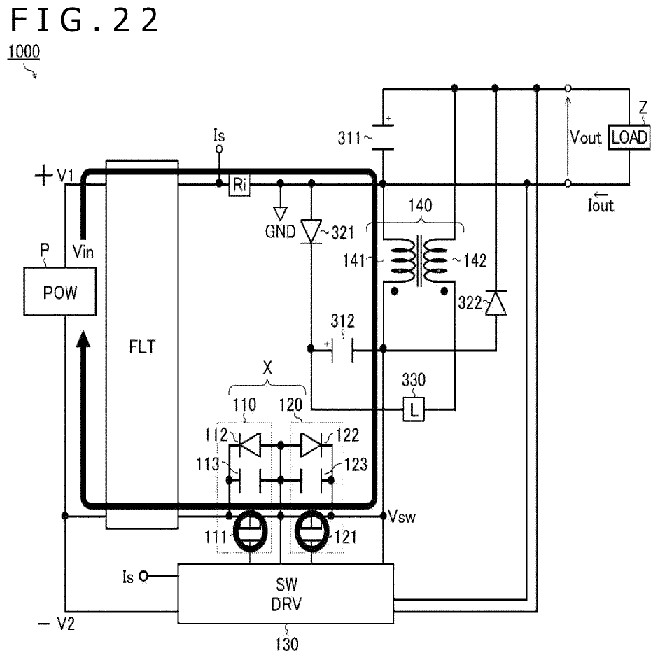

FIG. 21 illustrates a first operation example (V1>V2) of the individual ZVS control in the tenth embodiment, and FIG. 21 depicts the switch voltage Vsw appearing at one end of the bidirectional switch X (=drain of switch element 120) and the on/off states of the switch elements 110 and 120. Each of FIGS. 22 to 28 illustrates the current path in each phase of the first operation example.

Both the switch elements 110 and 120 are turned on before time t61. In this case, the primary current flows in the current path from the first node of the AC power supply P (=application end of voltage V1) to the second node of the AC power supply P (=application end of voltage V2) through the resistance Ri, the primary winding 141, and the bidirectional switch X, and energy is stored in the primary winding 141, as illustrated in FIG. 22. Note that the switch voltage Vsw coincides with the voltage V2 at this point.

Once predetermined energy is stored in the primary winding 141 at time t61, the switch driving apparatus 130 switches the bidirectional switch X from on to off. The switch driving apparatus 130 may turn off the bidirectional switch X when the switch driving apparatus 130 detects the passage of a predetermined time period from the on timing of the bidirectional switch X or when the switch driving apparatus 130 detects that the integral value of the primary current has reached a predetermined threshold.

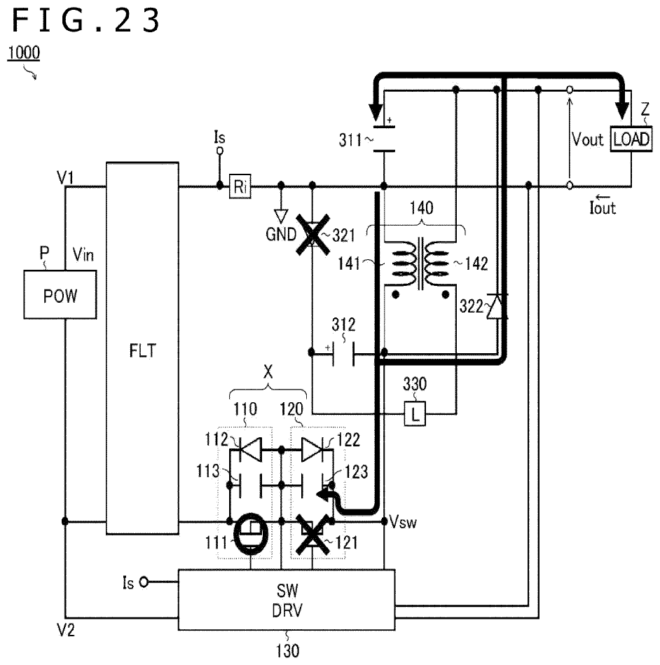

In this case, the switch driving apparatus 130 does not turn off the switch elements 110 and 120 at the same time. The switch driving apparatus 130 turns off the switch element 120 including the reverse biased internal diode 122 (=element provided with reverse voltage) while keeping the switch element 110 including the forward biased internal diode 112 (=element provided with forward voltage) turned on as illustrated in FIG. 23.

Along with the rise in the switch voltage Vsw, the voltage between the drain and the source of the switch element 120 (=Vsw−V2) gradually rises while energy is mainly stored in the internal capacitance 123 of the switch element 120. Note that the switch voltage Vsw rises until the absolute value of the switch voltage Vsw coincides with the DC output voltage Vout.

Once the switch voltage Vsw becomes higher than the total voltage of the voltage between the ends of the capacitor 311 and the forward direction drop voltage of the diode 322, the current flows into the capacitor 311 through the diode 322, and the capacitor 311 is charged, as illustrated in FIG. 23.

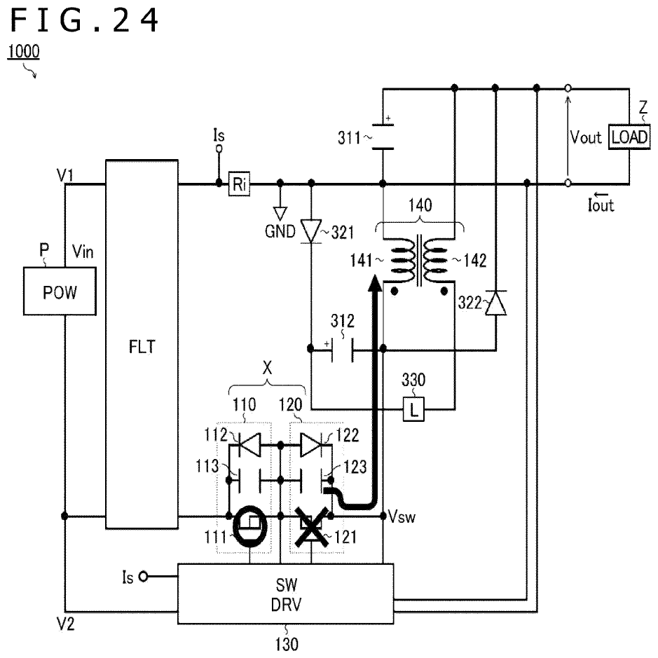

Once all the energy stored in the transformer 140 is discharged to the capacitor 311 at time t62, regeneration of the primary current from the bidirectional switch X to the primary winding 141 is started due to the internal capacitance 123 of the switch element 120 and other capacitances as illustrated in FIG. 24. As a result, the switch voltage Vsw starts to fall, and the voltage between the drain and the source of the switch element 120 gradually falls.

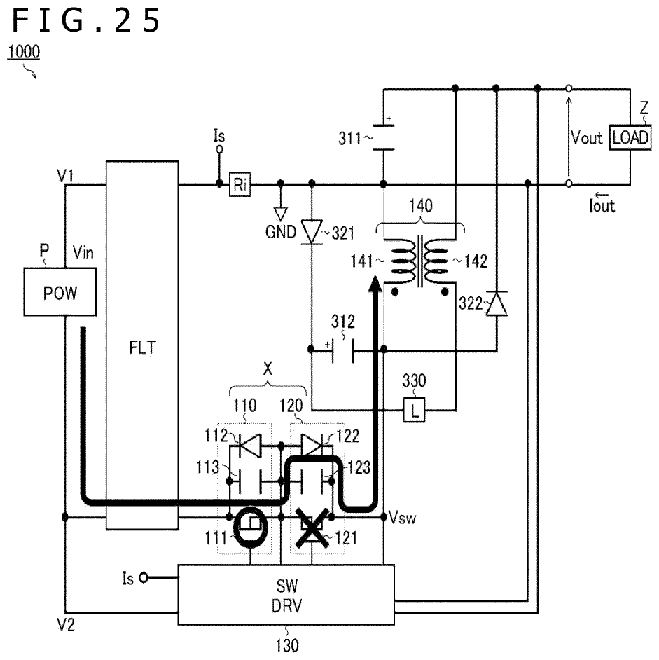

At time t63, the primary current is regenerated in the current path from the second node of the AC power supply P (=application end of voltage V2) to the primary winding 141 through the switch function unit 111 of the switch element 110 and the internal diode 122 of the switch element 120 as illustrated in FIG. 25. In this state, the switch voltage Vsw is clamped to a voltage equivalent to the voltage V2 minus the forward direction drop voltage of the internal diode 122.

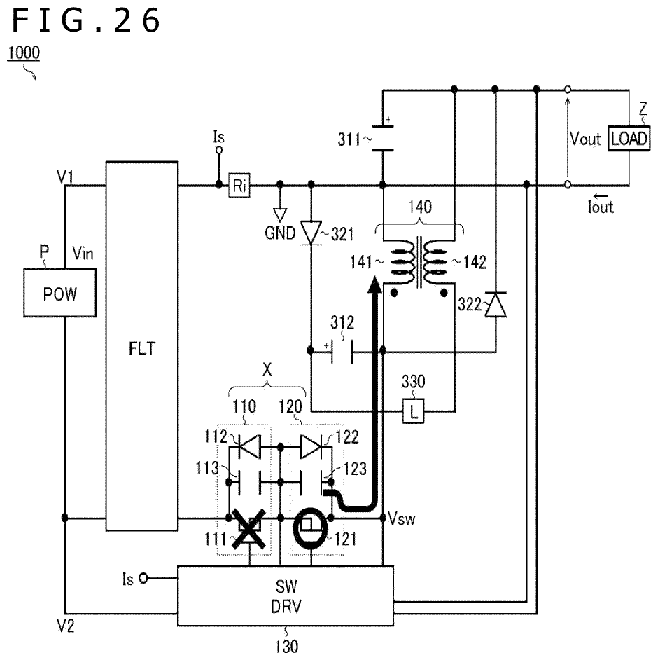

The switch driving apparatus 130 determines the timing to turn on the switch element 120 and turn off the switch element 110 at the same time and performs such turning on of and turning off at the same time as illustrated in FIG. 26. The clamp of the switch voltage Vsw is cancelled by the switching control.

As a result, the resonance operation is continued by the energy stored in the transformer 140, and the switch voltage Vsw falls to a potential lower than the voltage V2. Accordingly, the voltage between the drain and the source of the switch element 110 (=V2−Vsw) rises, and a reverse voltage is applied to the switch element 110 (that is, internal diode 112 of switch element 110 is reverse biased).

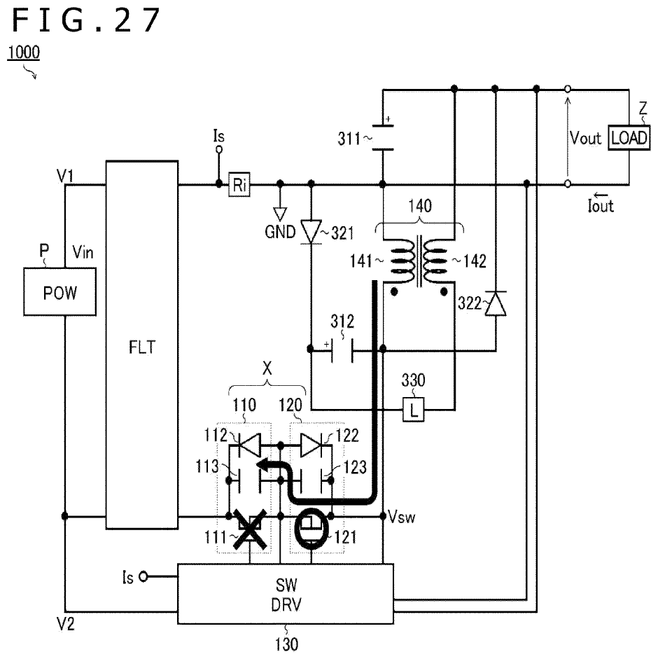

When there is no more energy stored in the transformer 140 at time t64, the regeneration of the primary current ends, and the primary current starts to flow again from the primary winding 141 to the bidirectional switch X, as illustrated in FIG. 27. The direction of the primary current is the same as that before time t61, and energy is stored in the primary winding 141. As a result, the switch voltage Vsw starts to rise due to the internal capacitance 113 of the switch element 110 and other capacitances, and the voltage between the drain and the source of the switch element 110 gradually falls.

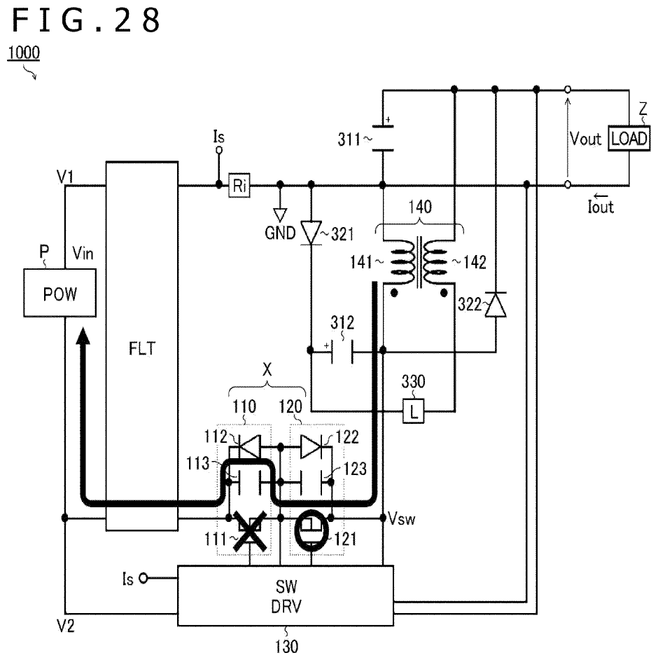

At time t65, the primary current flows in the current path from the primary winding 141 to the second node of the AC power supply P (=application end of voltage V2) through the switch function unit 121 of the switch element 120 and the internal diode 112 of the switch element 110 as illustrated in FIG. 28. In this state, the switch voltage Vsw is clamped to a voltage equivalent to the voltage V2 plus the forward direction drop voltage of the internal diode 112.

The switch driving apparatus 130 determines the timing to turn on the switch element 110 and performs such turning on while keeping the switch element 120 turned on. As a result of the switching control, the switching power supply 1000 returns to the state similar to that before time t61 (FIG. 22).

In this way, to switch the bidirectional switch X from off to on in the first operation example of FIG. 21 (V1>V2), the switch driving apparatus 130 performs first ZVS control to turn on the turned-off switch element 120 at such a timing that the voltage between the ends of the switch element 120 becomes 0 V. The switch driving apparatus 130 then performs second ZVS control to turn off the switch element 110 at such a timing that the switch element 120 is turned on and to turn on the switch element 110 at such a timing that the voltage between the ends of the switch element 110 becomes 0 V.

The switching control can be repeated to individually turn on the switch elements 110 and 120 at such a timing that charge is not stored in the respective internal capacitances 113 and 123 of the switch elements 110 and 120 during the on transition of the bidirectional switch X. The primary winding 141 is excited for the next energy transport substantially from time t64, and the primary winding 141 effectively uses part of the resonance energy without regeneration. Accordingly, the switching loss of each of the switch elements 110 and 120 can be reduced, and the heat generation of the bidirectional switch X can be suppressed.

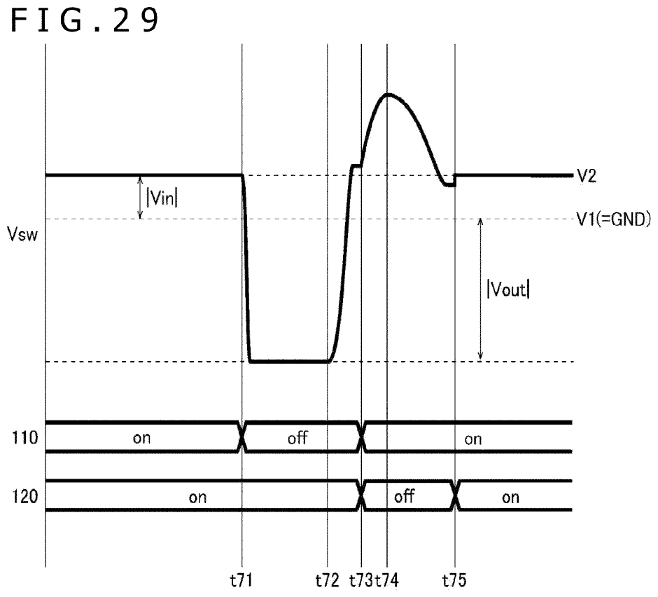

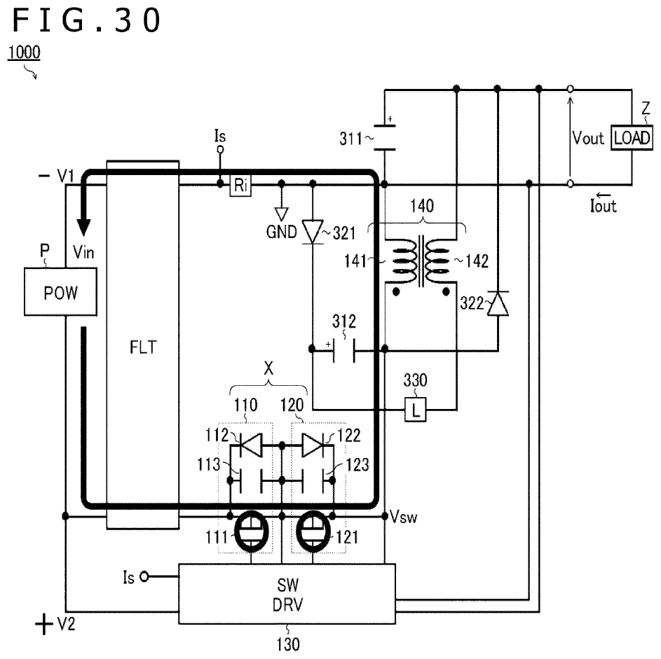

FIG. 29 illustrates a second operation example (V1<V2) of the individual ZVS control in the tenth embodiment, and FIG. 29 depicts the switch voltage Vsw appearing at one end of the bidirectional switch X (=drain of switch element 120) and the on/off states of the switch elements 110 and 120. Each of FIGS. 30 to 36 illustrates the current path in each phase of the second operation example.

Both the switch elements 110 and 120 are turned on before time t71. In this case, the primary current flows in the current path from the second node of the AC power supply P (=application end of voltage V2) to the first node of the AC power supply P (=application end of voltage V1) through the bidirectional switch X, the primary winding 141, and the resistance Ri, and energy is stored in the primary winding 141, as illustrated in FIG. 30. Note that the switch voltage Vsw coincides with the voltage V2 at this point.

Once predetermined energy is stored in the primary winding 141 at time t71, the switch driving apparatus 130 switches the bidirectional switch X from on to off. The switch driving apparatus 130 may turn off the bidirectional switch X when the switch driving apparatus 130 detects the passage of a predetermined time period from the on timing of the bidirectional switch X or when the switch driving apparatus 130 detects that the integral value of the primary current has reached a predetermined threshold.

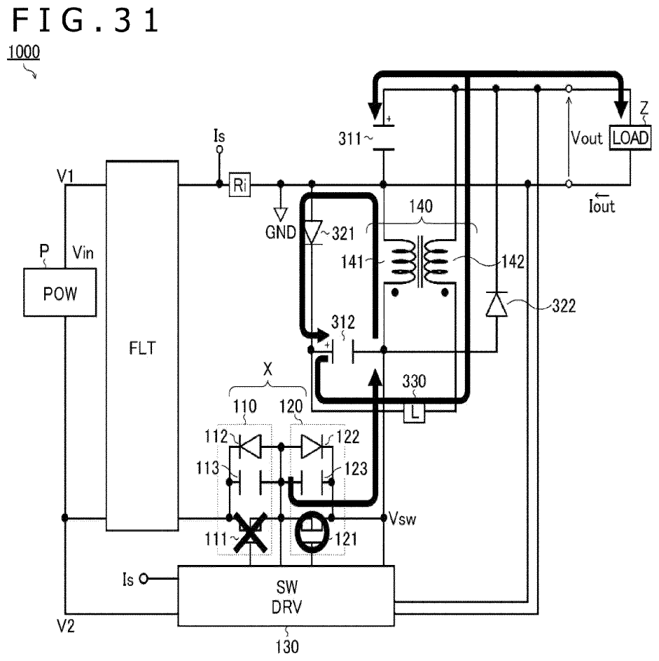

In this case, the switch driving apparatus 130 does not turn off the switch elements 110 and 120 at the same time. The switch driving apparatus 130 turns off the switch element 110 including the reverse biased internal diode 112 (=element provided with reverse voltage) while keeping the switch element 120 including the forward biased internal diode 122 (=element provided with forward voltage) turned on as illustrated in FIG. 31.

Along with the fall in the switch voltage Vsw, the voltage between the drain and the source of the switch element 110 (=V2−Vsw) gradually rises while energy is mainly stored in the internal capacitance 113 of the switch element 110. Note that the switch voltage Vsw falls until the absolute value of the switch voltage Vsw coincides with the DC output voltage Vout.

Once the switch voltage Vsw becomes lower than the total voltage of the voltage between the ends of the capacitor 312 and the forward direction drop voltage of the diode 321, the current flows into the capacitor 312 through the diode 321, and the capacitor 312 is charged, as illustrated in FIG. 31. The energy stored in the capacitor 312 is further used to charge the capacitor 311 through the auxiliary winding 330 and the secondary winding 142.

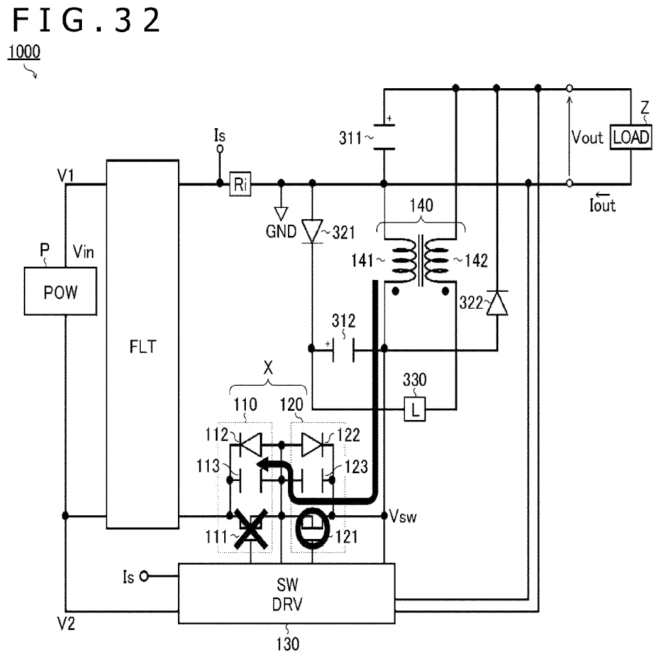

Once all the energy stored in the transformer 140 is discharged to the capacitor 311 at time t72, regeneration of the primary current from the primary winding 141 to the bidirectional switch X is started as illustrated in FIG. 32. As a result, the switch voltage Vsw starts to rise due to the internal capacitance 113 of the switch element 110 and other capacitances, and the voltage between the drain and the source of the switch element 110 gradually falls.

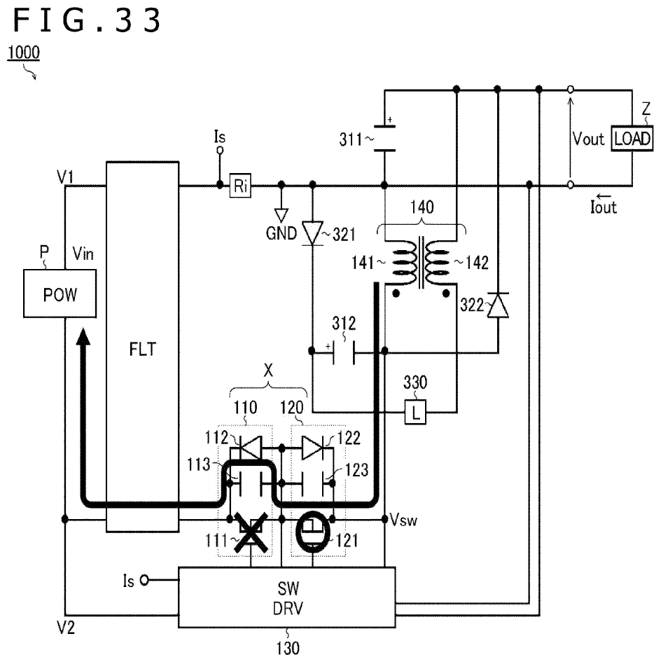

At time t73, the primary current is regenerated in the current path from the primary winding 141 to the second node of the AC power supply P (=application end of voltage V2) through the switch function unit 121 of the switch element 120 and the internal diode 112 of the switch element 110 as illustrated in FIG. 33. In this state, the switch voltage Vsw is clamped to a voltage equivalent to the voltage V2 plus the forward direction drop voltage of the internal diode 112.

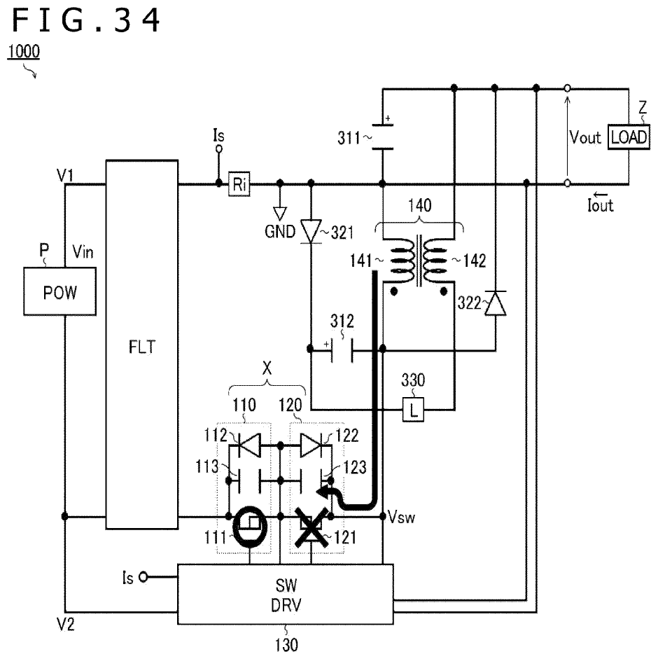

The switch driving apparatus 130 determines the timing to turn on the switch element 110 and turn off the switch element 120 at the same time and performs such turning on and turning off at the same time as illustrated in FIG. 34. The clamp of the switch voltage Vsw is cancelled by the switching control.

As a result, the resonance operation is continued by the energy stored in the transformer 140, and the switch voltage Vsw rises to a potential higher than the voltage V2. Accordingly, the voltage between the drain and the source of the switch element 120 (=Vsw−V2) rises, and a reverse voltage is applied to the switch element 120 (that is, internal diode 122 of switch element 120 is reverse biased).

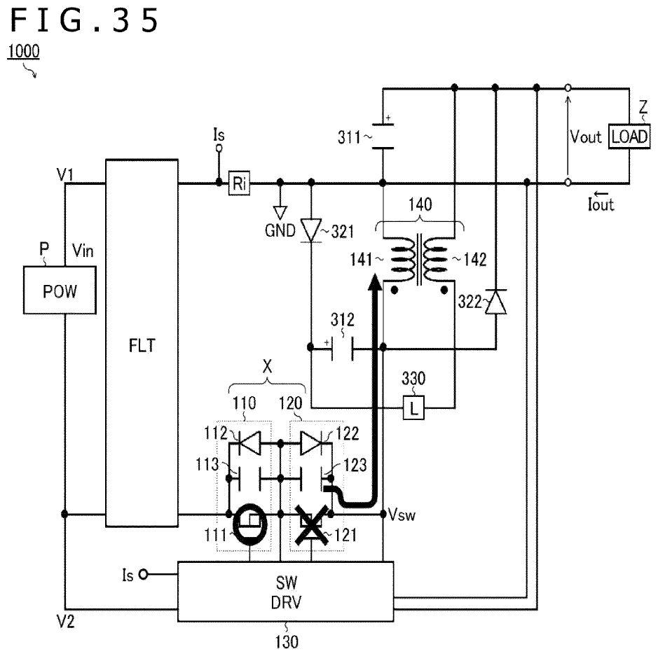

When there is no more energy stored in the transformer 140 at time t74, the regeneration of the primary current ends, and the primary current starts to flow again from the bidirectional switch X to the primary winding 141, as illustrated in FIG. 35. The direction of the primary current is the same as that before time t71, and the energy is stored in the primary winding 141. As a result, the switch voltage Vsw starts to fall due to the internal capacitance 123 of the switch element 120 and other capacitances, and the voltage between the drain and the source of the switch element 120 gradually falls.

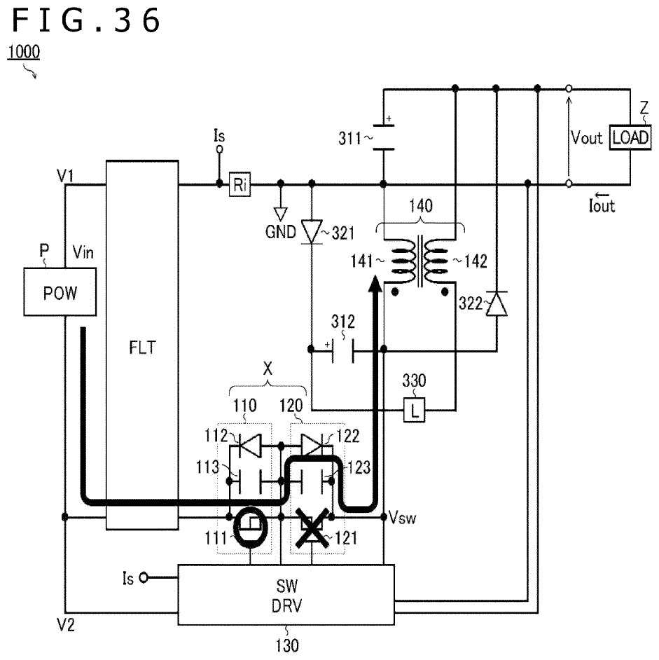

At time t75, the primary current flows in the current path from the second node of the AC power supply P (=application end of voltage V2) to the primary winding 141 through the switch function unit 111 of the switch element 110 and the internal diode 122 of the switch element 120 as illustrated in FIG. 36. In this state, the switch voltage Vsw is clamped to a voltage equivalent to the voltage V2 minus the forward direction drop voltage of the internal diode 122.

The switch driving apparatus 130 determines the timing to turn on the switch element 120 and performs such turning on while keeping the switch element 110 turned on. As a result of the switching control, the switching power supply 1000 returns to the state similar to that before time t71 (FIG. 30).

In this way, to switch the bidirectional switch X from off to on in the second operation example of FIG. 29 (V1<V2), the switch driving apparatus 130 performs first ZVS control to turn on the turned-off switch element 110 at such a timing that the voltage between the ends of the switch element 110 becomes 0 V. The switch driving apparatus 130 then performs second ZVS control to turn off the switch element 120 at such a timing that the switch element 110 is turned on and to turn on the switch element 120 at such a timing that the voltage between the ends of the switch element 120 becomes 0 V.

The switching control can be repeated to individually turn on the switch elements 110 and 120 at such a timing that charge is not stored in the respective internal capacitances 113 and 123 of the switch elements 110 and 120 during the on transition of the bidirectional switch X. Accordingly, the switching loss of each of the switch elements 110 and 120 can be reduced, and heat generation of the bidirectional switch X can be suppressed.

<Consideration on Stop of on/Off Drive>

In the switching power supply 1000 of the present embodiment (as well as in the switching power supplies 100 to 900 of the other embodiments), the on/off drive of the bidirectional switch X is forcibly stopped in some cases according to a predetermined stop trigger STOP.

For example, at the timing that the polarity of the AC input voltage Vin is inverted (for example, −12 V<Vin<+12 V), sufficient excitation may not be expected even if the bidirectional switch X is driven. Hence, the on/off drive of the bidirectional switch X can be stopped to reduce the switching loss of each of the switch elements 110 and 120 and improve the efficiency.

The on/off drive of the bidirectional switch X may also be stopped when the primary current flowing through the primary winding 141 becomes larger than the upper limit and the overcurrent prevent function is activated or when the DC output voltage Vout becomes higher than the upper limit and the overvoltage prevention function is activated.

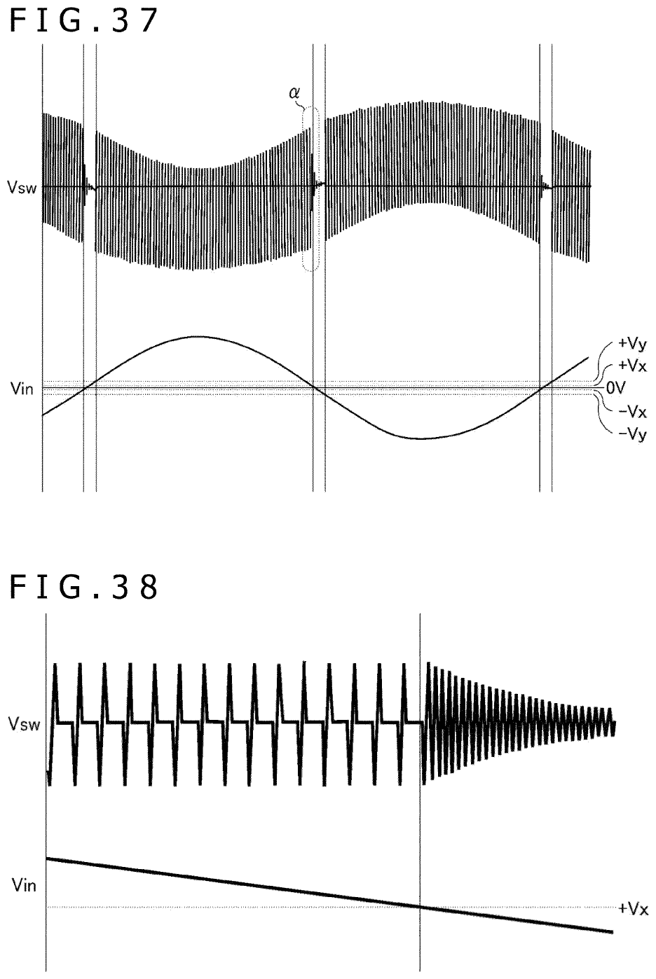

FIG. 37 illustrates a state in which the on/off drive of the bidirectional switch X is stopped at the polarity inversion timing of the AC input voltage Vin, and FIG. 37 depicts the switch voltage Vsw and the AC input voltage Vin. FIG. 38 is an enlarged view of a region a in FIG. 37.

As illustrated in FIG. 37, when the AC input voltage Vin is switched from the negative polarity to the positive polarity, the on/off drive of the bidirectional switch X is stopped at the timing of Vin>−Vx (for example, −12V), and then the on/off drive of the bidirectional switch X is restarted at the timing of Vin>+Vy (for example, +36 V).

When the AC input voltage Vin is switched from the positive polarity to the negative polarity, the on/off drive of the bidirectional switch X is stopped at the timing of Vin<+Vx (for example, +12 V), and then the on/off drive of the bidirectional switch X is restarted at the timing of Vin<−Vy (for example, −36 V).

In this way, both the switch elements 110 and 120 are turned off when the on/off drive of the bidirectional switch X is to be stopped. In this case, the ZVS control is not typically applied to the bidirectional switch X. Therefore, energy is stored in the primary winding 141 or the internal capacitances 113 and 123 in some cases depending on the excitation state and the resonance state just before the bidirectional switch X is turned off, and the LC resonance may occur due to the energy that has nowhere to go.

Note that the LC resonance may become a source of noise. The LC resonance may adversely affect the circuit operation if the LC resonance continues until the timing of the restart of the on/off drive. As such, a drive stopping process that can suppress the LC resonance will be proposed below.

### <Drive Stopping Process>

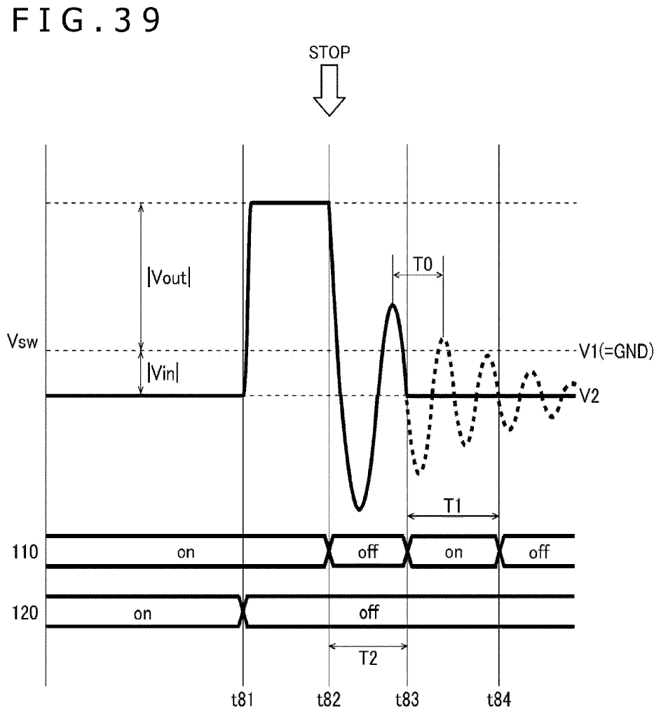

FIG. 39 illustrates a first example (V1>V2) of the drive stopping process executed by the switch driving apparatus 130 (particularly, controller 133), and FIG. 39 depicts the switch voltage Vsw and the on/off states of the switch elements 110 and 120. Note that a solid line of the switch voltage Vsw represents a behavior in the new drive stopping process, and a dashed line represents a behavior when the switch elements 110 and 120 are simply turned off.

The bidirectional switch X is turned on before time t81. Hence, the primary current flows to the primary winding 141, and energy is stored. The switch voltage Vsw coincides with the voltage V2 at this point.

Once predetermined energy is stored in the primary winding 141 at time t81, the bidirectional switch X is switched from on to off. More specifically, the switch element 120 is turned off while the switch element 110 is kept turned on. As a result, the switch voltage Vsw rises until the absolute value of the switch voltage Vsw coincides with the DC output voltage Vout.

At time t82, the on/off drive of the bidirectional switch X is stopped when there is some kind of stop trigger STOP (such as polarity inversion of AC input voltage Vin, overcurrent protection, or overvoltage protection). That is, both the switch elements 110 and 120 are turned off. In this case, energy is stored in the primary winding 141, and the LC resonance occurs due to the energy that has nowhere to go.

After both the switch elements 110 and 120 are turned off in this way, the switch element 110 is temporarily turned on for a predetermined on time period T1 from time t83 to t84. That is, the switch element 110 is turned on at time t83 and turned off again at time t84.

The switch element 110 temporarily turned on here is one of the switch elements 110 and 120 in which the internal diode 112 is reverse biased when the primary current is regenerated from the bidirectional switch X to the primary winding 141 (see FIG. 25).

According to such a drive stopping process, the resonance energy (=energy stored in primary winding 141 or internal capacitances 113 and 123) can be regenerated in the AC power supply P, and the LC resonance can be suppressed.

Note that the on time period T1 of the switch element 110 can be set to a length equal to or longer than a resonance period T0. The length of the resonance period T0 basically corresponds to the inductance of the primary winding 141 and the internal capacitance of the bidirectional switch X (=one of internal capacitances 113 and 123).

After both the switch elements 110 and 120 are turned off, the switch element 110 is turned on after the passage of a waiting time period T2 in FIG. 39, and the waiting time period T2 can optionally be adjusted.

For example, to prioritize the suppression of the LC resonance, the waiting time period T2 may be set to zero (or substantially zero), and only the switch element 110 may be turned on again immediately after both the switch elements 110 and 120 are turned off. On the other hand, a longer waiting time period T2 may be set to prioritize the safety in preparation for the application of the stop trigger STOP caused by the activation of the abnormality protection function.

The waiting time period T2 may be individually set according to the type of stop trigger STOP. For example, the safety can be prioritized to set a longer waiting time period T2 when an overcurrent is detected, and the suppression of the LC resonance can be prioritized to set a shorter waiting time period T2 when an overvoltage is detected.

At the polarity inversion of the AC input voltage Vin, energy is not stored much in the primary winding 141 in the first place, and the amplitude of the LC resonance is not so large. In view of this, at the polarity inversion of the AC input voltage Vin, both the switch elements 110 and 120 may be turned off, and both the switch elements 110 and 120 may be kept turned off without the switch element 110 being temporarily turned on.

Although the stop trigger STOP is applied when the switch element 110 is turned on and the switch element 120 is turned off in the case illustrated in FIG. 39, there may be a case in which the stop trigger STOP is applied when the switch element 110 is turned off and the switch element 120 is turned on (for example, time t63 to t65 in FIG. 21). In this case, the LC resonance can be converged earlier by causing the switch element 120 to be temporarily turned on instead of the switch element 110.

In this way, if the state of the LC resonance is completely recognized, more appropriate one of the switch elements 110 and 120 can be temporarily turned on for the on time period T1 to suppress the LC resonance. Note that it is only necessary to set the on time period T1 in this case to a length at least longer than half the resonance period T0.

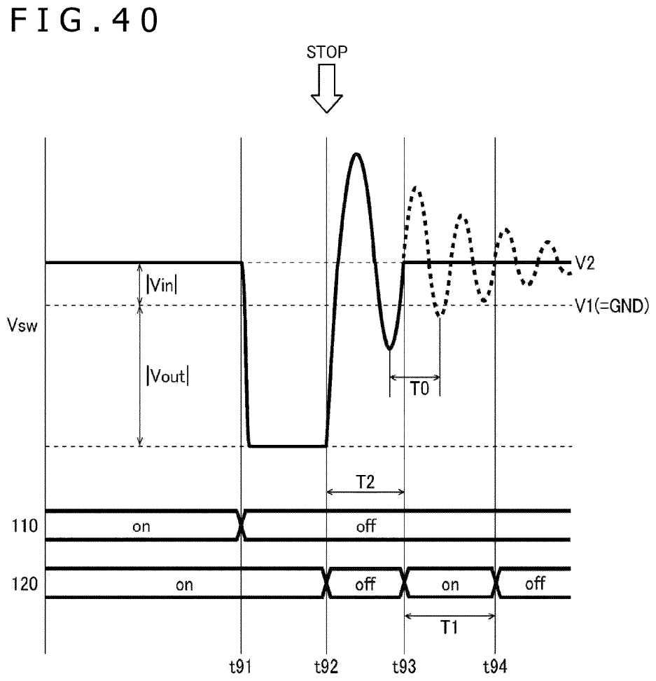

FIG. 40 illustrates a second example (V1<V2) of the drive stopping process executed by the switch driving apparatus 130 (particularly, controller 133), and FIG. 40 depicts the switch voltage Vsw and the on/off states of the switch elements 110 and 120 as in FIG. 39. Note that a solid line of the switch voltage Vsw represents a behavior in the new drive stopping process, and a dashed line represents a behavior when the switch element 110 and 120 are simply turned off.

The bidirectional switch X is turned on before time t91. Accordingly, the primary current flows to the primary winding 141, and energy is stored. The switch voltage Vsw coincides with the voltage V2 at this point.

Once predetermined energy is stored in the primary winding 141 at time t91, the bidirectional switch X is switched from on to off. More specifically, the switch element 110 is turned off while the switch element 120 is kept turned on. As a result, the switch voltage Vsw falls until the absolute value of the switch voltage Vsw coincides with the DC output voltage Vout.

At time t92, the on/off drive of the bidirectional switch X is stopped when there is some kind of stop trigger STOP (such as polarity inversion of AC input voltage Vin, overcurrent protection, or overvoltage protection). That is, both the switch elements 110 and 120 are turned off. In this case, energy is stored in the primary winding 141, and the LC resonance occurs due to the energy that has nowhere to go.

After both the switch elements 110 and 120 are turned off in this way, the switch element 120 is temporarily turned on for the predetermined on time period T1 from time t93 to t94. That is, the switch element 120 is turned on at time t93 and turned off again at time t94.

The switch element 120 temporarily turned on here is one of the switch elements 110 and 120 in which the internal diode 122 is reverse biased when the primary current is regenerated from the primary winding 141 to the bidirectional switch X (see FIG. 33).

According to the drive stopping process, the resonance energy (=energy stored in primary winding 141 or internal capacitances 113 and 123) can be regenerated in the AC power supply P as in the first operation example (FIG. 39), and the LC resonance can be suppressed. The second operation example is also similar to the first operation example in other respects, and the description will not be repeated.

### SUMMARY

A summary of various embodiments described in the present specification will be given below.

For example, a switch driving apparatus disclosed in the present specification includes a controller configured to individually control a first switch element and a second switch element included in a bidirectional switch, in which, when the controller stops on/off drive of the bidirectional switch, the controller turns off both the first switch element and the second switch element and then temporarily turns on one of the first switch element and the second switch element for a predetermined on time period (first configuration).

In the switch driving apparatus according to the first configuration, the switch element to be temporarily turned on may be a switch element in which an internal diode is reverse biased during current regeneration (second configuration).

In the switch driving apparatus according to the first or second configuration, the on time period may be set to a length equal to or greater than a resonance period (third configuration).

In the switch driving apparatus according to any one of the first to third configurations, when the controller switches the bidirectional switch from on to off, the controller may keep one of the first switch element and the second switch element turned on and turn off the other switch element (fourth configuration).

In the switch driving apparatus according to the fourth configuration, when the controller switches the bidirectional switch from off to on, the controller may perform first zero-voltage switching control to turn on the other switch element at such a timing that a voltage between ends of the other switch element becomes 0 V (fifth configuration).

In the switch driving apparatus according to the fifth configuration, when the controller switches the bidirectional switch from off to on, the controller may perform second zero-voltage switching control following the first zero-voltage switching control to turn off the one switch element at such a timing that the other switch element is turned on and to turn on the one switch element at such a timing that a voltage between ends of the one switch element becomes 0 V (sixth configuration).

For example, a switching power supply disclosed in the present specification includes a primary winding configured to be provided with an AC input voltage, a secondary winding configured to be coupled to the primary winding, a bidirectional switch configured to be connected in series to the primary winding, a full-wave rectifier circuit configured to perform full-wave rectification of an induced voltage generated in the secondary winding, a smoothing capacitor configured to smooth output of the full-wave rectifier circuit, and the switch driving apparatus according to any one of the first to sixth configurations that drives the bidirectional switch, in which the switching power supply takes out a flyback voltage or both a forward voltage and a flyback voltage from the secondary winding to directly convert the AC input voltage into a DC output voltage (seventh configuration).

In the switching power supply according to the seventh configuration, the switch driving apparatus may stop the on/off drive of the bidirectional switch when an absolute value of the AC input voltage is smaller than a lower limit (eighth configuration).

In the switching power supply according to the seventh or eighth configuration, the switch driving apparatus may stop the on/off drive of the bidirectional switch when the DC output voltage is higher than an upper limit (ninth configuration).

In the switching power supply according to any one of the seventh to ninth configurations, the switch driving apparatus may stop the on/off drive of the bidirectional switch when a primary current flowing through the primary winding is larger than an upper limit (tenth configuration).

### <Other Modifications>

Various technical features disclosed in the present specification can be changed in various ways without departing from the scope of the embodiments and the technical creation of the embodiments. That is, the embodiments are illustrative in all aspects and should not be construed as restrictive. The technical scope of the present technology is not limited to the embodiments, and it should be understood that all changes within the meaning and range of equivalents of the claims are included in the technical scope of the present technology.

What is claimed is:

1. A switch driving apparatus comprising:
a controller configured to individually control a first switch element and a second switch element included in a bidirectional switch, wherein,
when the controller stops on/off drive of the bidirectional switch, the controller turns off both the first switch element and the second switch element and then temporarily turns on one of the first switch element and the second switch element for a predetermined on time period.

2. The switch driving apparatus according to claim 1, wherein
the switch element to be temporarily turned on is a switch element in which an internal diode is reverse biased during current regeneration.

3. The switch driving apparatus according to claim 1, wherein
the on time period is set to a length equal to or greater than a resonance period.

4. The switch driving apparatus according to claim 1, wherein,
when the controller switches the bidirectional switch from on to off, the controller keeps one of the first switch element and the second switch element turned on and turns off the other switch element.

5. The switch driving apparatus according to claim 4, wherein,
when the controller switches the bidirectional switch from off to on, the controller performs first zero-voltage switching control to turn on the other switch element at such a timing that a voltage between ends of the other switch element becomes 0 V.

6. The switch driving apparatus according to claim 5, wherein,
when the controller switches the bidirectional switch from off to on, the controller performs second zero-voltage switching control following the first zero-voltage switching control to turn off the one switch element at such a timing that the other switch element is turned on and to turn on the one switch element at such a timing that a voltage between ends of the one switch element becomes 0 V.

7. A switching power supply comprising:
a primary winding configured to be provided with an alternating current input voltage;
a secondary winding coupled to the primary winding;
a bidirectional switch connected in series to the primary winding;
a full-wave rectifier circuit configured to perform full-wave rectification of an induced voltage generated in the secondary winding;
a smoothing capacitor configured to smooth output of the full-wave rectifier circuit; and
the switch driving apparatus according to claim 1 that drives the bidirectional switch, wherein
the switching power supply takes out a flyback voltage or both a forward voltage and a flyback voltage from the secondary winding to directly convert the alternating current input voltage into a direct current output voltage.

8. The switching power supply according to claim 7, wherein
the switch driving apparatus stops the on/off drive of the bidirectional switch when an absolute value of the alternating current input voltage is smaller than a lower limit.

9. The switching power supply according to claim 7, wherein
the switch driving apparatus stops the on/off drive of the bidirectional switch when the direct current output voltage is higher than an upper limit.

10. The switching power supply according to claim 7, wherein
the switch driving apparatus stops the on/off drive of the bidirectional switch when a primary current flowing through the primary winding is larger than an upper limit.
